(19) United States
(12) Patent Application Publication
(10) Pub. No.: US 2024/0254809 A1
(43) Pub. Date: Aug. 1, 2024

(54) CASES FOR ELECTRONIC TRACKING DEVICES

(71) Applicant: Catalyst Lifestyle Limited, Hong Kong (CN)

(72) Inventors: Joshua Wright, Hong Kong (CN); June Lai, Hong Kong (CN)

(73) Assignee: Catalyst Lifestyle Limited, Hong Kong (CN)

(21) Appl. No.: 18/560,809

(22) PCT Filed: May 26, 2022
(86) PCT No.: PCT/US22/31114

§ 371 Date: Nov. 14, 2023

Related U.S. Application Data
(60) Provisional application No. 63/193,548, filed on May 26, 2021.
(60) Provisional application No. 63/228,511, filed on Aug. 2, 2021.

(51) Int. Cl. E05B 67/22; E05B 65/52; G06K 19/077

(52) U.S. Cl. CPC E05B 67/22; E05B 65/5246; G06K 19/07749

(57) ABSTRACT

A case for an electronic tracking device, the case includes a base defining a cavity, a cap including a front member and one or more sidewalls that extend transversely from an inner surface of the front member, and a sealing member positioned between the cap and the base, wherein the cap is releasably coupled to the base and, when coupled to the base, the sealing member is compressed between the cap to the base to seal the cavity in the base.

### CROSS-REFERENCE TO RELATED APPLICATIONS

The present application claims the priority benefit of U.S. Provisional Application No. 63/193.548, filed May 26, 2021 and entitled “Protective Cases for Electronic Tracking Devices” and U.S. Provisional Application No. 63/228,511, filed Aug. 2, 2021 and entitled “Protective Cases for Electronic Tracking Devices,” the entire contents of both are incorporated herein in their respective entireties.

### TECHNICAL FIELD

The present specification generally relates to cases and, more specifically, to cases having additional features.

### BACKGROUND

Tracking devices, including electronic tracking devices (e.g., an AirTag® made by Apple Inc. (Cupertino. CA) or the like) may be retained within cases that prevent the electronic tracking devices from getting scratched dinged, marred, contacted with fluid (e.g., wet), or the like. In addition, cases may absorb an impact sustained when dropped. In order to provide additional protection against falls or fluid contact, cases may be arranged around the electronic tracking device. Users may desire to attach certain accessories to the case in order to minimize the amount of items that have to be carried and/or such that the electronic tracking device can be carried on another object for the purposes of tracking that object. However, existing cases for tracking devices either leave portions of the electronic tracking device exposed to the elements or completely encompass the electronic tracking device in a manner that prevents sound transmission from the electronic tracking device to be readily heard by a user when the electronic tracking device is held within the case.

### SUMMARY

In one aspect, a case for an electronic tracking device, the case includes a base defining a cavity, a cap including a front member and one or more sidewalls that extend transversely from an inner surface of the front member, and a sealing member positioned between the cap and the base, wherein the cap is releasably coupled to the base and, when coupled to the base, the sealing member is compressed between the cap to the base to seal the cavity in the base.

In another aspect, a case for an electronic tracking device includes a sleeve, a body, and a locking mechanism. The sleeve includes an end wall and an annular wall extending from the end wall, the end wall and the annular wall defining a cavity configured to receive the electronic tracking device. The body includes a hinge and an opening, the body configured to receive the sleeve through the opening such that the annular wall of the sleeve abuts an inner surface of the body. The locking mechanism is configured to lock the sleeve and the base together, wherein the annular wall of the sleeve is compressed by the inner surface of the base to seal the cavity.

In yet another aspect, a case for an electronic tracking device includes a cap including an end wall and an annular wall extending from the end wall, the end wall and the annular wall defining a cavity configured to receive the electronic tracking device, and wherein an inner surface of the annular wall contacts the electronic tracking device to seal the cavity.

In yet another aspect, a case for an electronic tracking device includes an inner sleeve and an outer sleeve. The inner sleeve includes an end wall and an annular wall extending from the end wall, the end wall and the annular wall defining an opening configured to receive the electronic tracking device such that a first side of the electronic tracking device abuts the end wall of the inner sleeve, wherein the annular wall further includes an outer surface defining sealing formations. The outer sleeve includes an end wall and an annular wall extending from the end wall, the end wall and the annular wall defining a cavity configured to receive the inner sleeve when assembled with the electronic tracking device such that a second side of the electronic tracking device abuts the end wall, wherein the annular wall further includes an inner surface including outer sealing formations. The sealing formations and the outer sealing formations couple the outer sleeve to the inner sleeve to seal the opening of the inner sleeve.

In yet another aspect, a lock for retaining an electronic tracking device, the lock includes a base, and a retaining member operable to enclose the electronic tracking device between the retaining member and the base.

In yet another aspect, a case for an electronic tracking device, the case includes a cap, a base coupled to the cap, the base and the cap are configured to enclose the electronic tracking device, and an attachment assembly including an attachment member that is coupled to the cap, a pair of tethers extending from the attachment member, and a pair of deformable cups coupled to each of the tethers.

In yet another aspect, a wearable case for an electronic tracking device, the case includes a housing including a pair of bands extending from a main body of the housing, and a cavity formed in the main body, the pair of bands are configured to be selectively coupled together. and a back-plate coupled to the housing to enclose the cavity, the cavity is configured to receive the electronic tracking device.

In yet another aspect, a case for an electronic tracking device, the case includes a sleeve including an inner cavity configured to receive the electronic tracking device, a rim, and a groove formed therein, and a fixing ring positioned in the groove of the sleeve.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a body of a first aspect case in a secured position according to one or more embodiments described herein;

FIG. 2 schematically depicts an exploded view of the case of FIG. 1 according to one or more embodiments described herein;

FIG. 3 schematically depicts a cross-sectional view of the case of FIG. 1 taken from line 3-3 according to one or more embodiments described herein;

FIG. 4 schematically depicts a cross-sectional view of another case, according to one or more embodiments described herein;

FIG. 5 schematically depicts a cross-sectional view of another case, according to one or more embodiments described herein;

FIG. 6 schematically depicts an exploded view of another case, according to one or more embodiments described herein;

FIG. 7 schematically depicts a case configured to be attached to a surface. according to one or more embodiments described herein;

FIG. 8 schematically depicts a cross-sectional view of the case of FIG. 7, according to one or more embodiments described herein;

FIG. 9 schematically depicts an isometric view of a case for an electronic tracking device, according to one or more embodiments shown and described herein;

FIG. 10 schematically depicts an exploded view of the case of FIG. 9, according to one or more embodiments shown and described herein;

FIG. 11 schematically depicts a cross-sectional view of another case, according to one or more embodiments described herein;

FIG. 12A schematically depicts a top isometric view of a case for an electronic tracking device, according to one or more embodiments shown and described herein;

FIG. 12B schematically depicts a bottom isometric view of the case of FIG. 12A. according to one or more embodiments shown and described herein;

FIG. 13 schematically depicts a case for an electronic tracking device including a retention feature for an external support structure, according to one or more embodiments described herein;

FIG. 14 schematically depicts a cross sectional view of the case of FIG. 13. according to one or more embodiments described herein;

FIG. 15 schematically depicts an exploded view of a case for an electronic tracking device including an attachment assembly for an external support structure, according to one or more embodiments described herein;

FIG. 16 schematically depicts a cross-sectional view of the case of FIG. 15, according to one or more embodiments described herein;

FIG. 17 schematically depicts a bottom isometric view of a case for an electronic tracking device with an attachment feature in a closed position, according to one or more embodiments shown and described herein;

FIG. 18 schematically depicts a bottom isometric view of the case of FIG. 17 with the attachment feature in an open position, according to one or more embodiments shown and described herein;

FIG. 19 schematically depicts an exploded view of a case for an electronic tracking device including an attachment assembly for an external support structure, according to one or more embodiments described herein;

FIG. 20 schematically depicts an isometric view of the case of FIG. 19 in an assembled state, according to one or more embodiments described herein;

FIG. 21 depicts a top perspective view of an illustrative modular case for an electronic tracking device, according to one or more embodiments shown and described herein;

FIG. 22 depicts an exploded view of the case of FIG. 21, according to one or more embodiments shown and described herein;

FIG. 23 depicts a partial cross-sectional view of the case of FIG. 21 taken along line 23-23, according to one or more embodiments shown and described herein;

FIG. 24 depicts an exploded view of another case including an attachment member. according to one or more embodiments shown and described herein;

FIG. 25A schematically depicts a first exploded view of a case for coupling to a housing of an electronic tracking device, according to one or more embodiments shown and described herein;

FIG. 25B schematically depicts a second exploded view of the case of FIG. 25A. according to one or more embodiments shown and described herein;

FIG. 25C schematically depicts a cross-sectional view of the case of FIG. 25A in an assembled state, according to one or more embodiments shown and described herein;

FIG. 26 schematically depicts an isometric view of another case for an electronic tracking device, according to one or more embodiments shown and described herein;

FIG. 27 schematically depicts a case configured to be attached to a surface, according to one or more embodiments described herein;

FIG. 28 schematically depicts a cross sectional view of the case of FIG. 27 taken along line 28-28, according to one or more embodiments described herein;

FIG. 29 depicts a top, perspective view of another case including an alternative attachment feature, according to one or more embodiments shown and described herein;

FIG. 30 depicts a top perspective view of another case including an alternative attachment feature, according to one or more embodiments shown and described herein;

FIG. 31 depicts a perspective view of an illustrative case for an electronic tracking device include a sleeve and an attachment member, according to one or more embodiments shown and described herein;

FIG. 32 depicts a partial cross-sectional view of the case of FIG. 31 taken along line 31-31, according to one or more embodiments shown and described herein;

FIG. 33 depicts a top perspective view of another case for an electronic tracking device including a plurality of attachment members, according to one or more embodiments shown and described herein;

FIG. 34 depicts a partial cross-sectional view of the case of FIG. 33, according to one or more embodiments shown and described herein;

FIG. 35 depicts a top perspective view of an illustrative case for an electronic tracking device including an inner sleeve and an outer sleeve, according to one or more embodiments shown and described herein;

FIG. 36 depicts a partial cross-sectional view of the case of FIG. 35, according to one or more embodiments shown and described herein;

FIG. 37 schematically depicts a case configured to be attached to a surface, according to one or more embodiments described herein;

FIG. 38 schematically depicts a cross sectional view of the case of FIG. 37 taken along line 38-38, according to one or more embodiments described herein;

FIG. 39 schematically depicts a cross sectional view of another case, according to one or more embodiments described herein;

FIG. 40A depicts a perspective view of an illustrative case for an electronic tracking device including a body and a locking mechanism, according to one or more embodiments shown and described herein;

FIG. 40B depicts a perspective view of the case of FIG. 40A with the electronic tracking device inserted into the body of the case, according to one or more embodiments shown and described herein;

FIG. 40C depicts a view of the case of FIG. 40A with the locking mechanism attached to the body of the case, according to one or more embodiments shown and described herein;

FIG. 40D depicts a partial cross-sectional view of the case of FIG. 40A, according to one or more embodiments shown and described herein;

FIG. 41A schematically depicts an isometric view of a lock for housing an electronic tracking device in an disengaged position, according to one or more embodiments shown and described herein;

FIG. 41B schematically depicts an isometric view of the lock of FIG. 41A. according to one or more embodiments shown and described herein;

FIG. 41C schematically depicts an isometric view of the lock of FIG. 41A in a engaged position, according to one or more embodiments shown and described herein;

FIG. 42A schematically depicts an isometric view of a lock for housing an electronic tracking device in a disengaged position, according to one or more embodiments shown and described herein;

FIG. 42B schematically depicts an isometric view of the lock of FIG. 42A in an engaged position, according to one or more embodiments shown and described herein;

FIG. 43 schematically depicts an isometric view of an alternative embodiment of the case of FIG. 42A, according to one or more embodiments shown and described herein;

FIG. 44A schematically depicts an isometric view of a housing for an electronic tracking device in an open position, according to one or more embodiments shown and described herein;

FIG. 44B schematically depicts an isometric view of the lock of FIG. 44A in a closed position, according to one or more embodiments shown and described herein;

FIG. 45 schematically depicts an exploded view of a case for an electronic tracking device, according to one or more embodiments shown and described herein;

FIG. 46 schematically depicts an isometric view of the case of FIG. 45, according to one or more embodiments shown and described herein;

FIG. 47 schematically depicts an isometric view of the case of FIG. 45 including an alternative sealing member, according to one or more embodiments shown and described herein;

FIG. 48 schematically depicts an exploded view of a case for an electronic tracking device, according to one or more embodiments shown and described herein;

FIG. 49 schematically depicts an isometric view of the case of FIG. 48, according to one or more embodiments shown and described herein;

FIG. 50 schematically depicts an exploded view of a case for an electronic tracking device, according to one or more embodiments shown and described herein;

FIG. 51 schematically depicts an isometric view of the case of FIG. 50, according to one or more embodiments shown and described herein;

FIG. 52 schematically depicts an exploded view of a case for an electronic tracking device, according to one or more embodiments shown and described herein;

FIG. 53 schematically depicts an isometric view of the case of FIG. 52, according to one or more embodiments shown and described herein;

FIG. 54 schematically depicts an exploded view of a case for an electronic tracking device, according to one or more embodiments shown and described herein;

FIG. 55 schematically depicts an isometric view of the case of FIG. 54, according to one or more embodiments shown and described herein;

FIG. 56 schematically depicts an exploded view of a case for an electronic tracking device, according to one or more embodiments shown and described herein;

FIG. 57 schematically depicts an isometric view of the case of FIG. 56, according to one or more embodiments shown and described herein;

FIG. 58 schematically depicts an exploded view of a case for an electronic tracking device, according to one or more embodiments shown and described herein;

FIG. 59 schematically depicts an isometric view of the case of FIG. 58, according to one or more embodiments shown and described herein;

FIG. 60 schematically depicts an exploded view of a case for an electronic tracking device, according to one or more embodiments shown and described herein;

FIG. 61 schematically depicts an isometric view of the case of FIG. 60, according to one or more embodiments shown and described herein;

FIG. 62 schematically depicts an isometric view of a case for an electronic tracking device, according to one or more embodiments shown and described herein;

FIG. 63 schematically depicts an exploded view of a case for an electronic tracking device, according to one or more embodiments shown and described herein;

FIG. 64 schematically depicts an isometric view of the case of FIG. 63, according to one or more embodiments shown and described herein;

FIG. 65 schematically depicts an exploded view of a case for an electronic tracking device, according to one or more embodiments shown and described herein;

FIG. 66 schematically depicts an isometric view of the case of FIG. 65, according to one or more embodiments shown and described herein;

FIG. 67 schematically depicts an exploded view of a case for an electronic tracking device, according to one or more embodiments shown and described herein;

FIG. 68A schematically depicts a top isometric view of the case of FIG. 67. according to one or more embodiments shown and described herein;

FIG. 68B schematically depicts a bottom isometric view of the case of FIG. 67. according to one or more embodiments shown and described herein;

FIG. 69 schematically depicts an exploded view of a case for an electronic tracking device, according to one or more embodiments shown and described herein; and

FIG. 70 schematically depicts an isometric view of the case of FIG. 69, according to one or more embodiments shown and described herein.

### DETAILED DESCRIPTION

The present disclosure generally relates to a case for a tracking device. The electronic tracking device generally includes any electronic tracking device, including any portable electronic device configured to emit one or more indicators (e.g., sound, light, etc.) of a presence thereof. One particular example of a tracking device that may be used with the embodiments described herein is an AirTag® manufactured and sold by Apple, Inc. (Cupertino. California). Electronic tracking devices according to some embodiments of the present disclosure may include one or more audio devices (e.g., microphones, speakers, and/or the like), buttons, switches (e.g., a sliding switch, such as a muting switch), and/or the like. As will be described herein, an electronic tracking device may be positioned within the case. The case may provide a protective and/or waterproof housing around the electronic tracking device, while at the same time ensuring that the full functionality of the electronic tracking device can be realized.

Each embodiment of the case, as detailed below, may be attached to a surface or an item. The case may be attached to toys, clothing, electronics, bags, vehicles, or other objects, particularly objects that may be subject to loss, misplacement, or the like. In some embodiments. the case may include features as described herein that provide a waterproof enclosure such that the case can be attached to items that may be exposed to water or the elements. Toys may include a pet toy, a child toy (such as a doll, action figure), or the like. Clothing may include a collar for a pet, a bracelet, jewelry, shoes, glasses, gloves, jackets, or the like, and may specifically be implemented in a coat check. Electronics may include a universal serial bus (USB), a drone, a power bank, a camera, camera accessories and attachments, a remote control. Apple AirPods® (manufactured and sold by Apple Inc. (Cupertino, CA)) or other earphones (such as via a lanyard attached to a case holding the AirPods® or other earphones), car keys, video game controllers or systems, a computer (such as a laptop, desktop, or tablet), a phone, or the like. Bags may include a purse, a wallet, a card holder, a golf bag, a backpack (such as via a handle of the backpack), a computer bag, a pencil bag, luggage, a beach container, a tool box, a camera bag, or the like. Vehicles may include a bike (such as a rental bike), a car (such as attached to a car mirror), a bike lock, valet parking, watercraft (e.g., a boat, a kayak, a canoe, a raft, a towable float, a water trampoline, etc.), a golf cart, or the like. Additional items or objects may include hiking accessories, an umbrella, a neck pillow, a water bottle, a hat holder, a car freshener, a book, a money clip, mail, a blanket, a safe, a passport or passport holder, an ID, a cup, a door security alarm, car keys, key fobs, a car freshener, valet or coat check tickets, a musical instrument, a skateboard, a scooter, a power cable, sports equipment, skiing equipment, documents or folders, books, a stroller, a zipper, a tripod, an oar or paddle, a floatation device, scuba equipment, fishing equipment, rowing equipment, surfing equipment, water skiing equipment, skim boarding equipment, underwater photography equipment, or any other item. The case may further be attached to medical devices and medicine, such as, for example, a medicine injector (e.g., an EpiPen® manufactured and sold by Mylan Inc. (Canonsburg. PA)), a medication storage unit (e.g., bottle, pill organizer, etc.), assistive devices such as hearing aids, cochlear implants, glasses, or the like, a health tracker, a CPAP or BiPAP machine and associated equipment, or the like.

Aspects described herein are generally directed to a case for an electronic tracking device. While the depicted electronic tracking device is an AirTag®, any tracking device may be enclosed within the case, including other types of electronic tracking devices (e.g., a Tile® device manufactured by Tile Inc. (San Mateo, CA)). An electronic tracking device may include any electronic device such as a GPS device, a tracking device, a tagging device, or the like. Electronic tracking devices according to the present disclosure may include one or more buttons, switches (e.g., a sliding switch, such as a muting switch), and/or the like. As will be described herein, an electronic tracking device may be positioned within the case. The case may provide a protective and/or waterproof housing around portions of the electronic tracking device.

In various embodiments described herein, the cases may generally include a base. a cap, an attachment portion, a coupling mechanism, and a sealing member. The base and the cap may generally define a cavity for retaining the electronic tracking device, the coupling mechanism may generally couple the base and cap together to enclose and retain the electronic tracking device in the cavity, and the sealing member may generally provide a seal to seal the cavity, thereby preventing the ingress and egress of fluid into the cavity. The attachment portion may be used to selectively couple the case to an external object for tracking the external object using the electronic tracking device. These components will be described with further specificity throughout the following description. As described throughout the ensuing description, the cases may include a plurality of embodiments for each of the base, the cap, the attachment portion, the coupling mechanism, and the sealing member for performing the above functions.

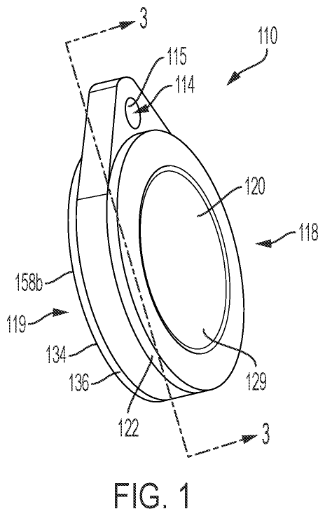

Referring initially to FIGS. 1-3, a first aspect of a case 110 for an electronic tracking device 116 is generally depicted. The electronic tracking device 116 described herein may include a first side 144a, an opposite second side 144b, and a protrusion 132 for coupling to cases. In some embodiments, the first side 144a may include indicia 146 such as, for example, a graphical design, an alphanumerical indicia, a customized or user defined designs, or the like. In some embodiments, the second side 144b may include similar indicia 148.

The case 110 may include a base 118 and a cap 119 that are selectively coupleable to be configured to enclose the electronic tracking device 116, and a sealing member 156. The base 118 may include a rear wall 120, one or more sidewalls 122 extending from the rear wall 120, and an attachment portion 114. The sidewalls 122 may extend transversely from the rear wall 120 at a periphery of the rear wall 120 to define a base cavity 124 within which the electronic tracking device 116 may be received.

The sidewalls 122 may include an inner surface 125 that faces the base cavity 124 to at least partially enclose the base cavity 124, and an outer surface 127 opposite the inner surface 125. The inner surface 125 may include a plurality of internal threads 126 that circumferential surround the inner surface 125 of the one or more sidewalls 122. The internal threads 126 may extend either partially or entirely along the length of the sidewalls 122. The attachment portion 114 may extend from a periphery of the sidewalls 122 opposite the inner surface 125. The attachment portion 114 may include an aperture 115 extending therethrough configured to receive an external attachment member for coupling the case 110 to an external object. The external attachment member may be any member capable of attaching the case 110 to an external object. such as, for example, a cord, a pin, a carabiner, a strap, or the like.

The rear wall 120 may include an inner surface 128 that faces the base cavity 124 to at least partially enclose the base cavity 124, and an outer surface 129 opposite the inner surface 128. The inner surface 128 may include a rib 130 that extends from the inner surface 128. The rib 130 may extend in parallel with the sidewalls 122, and be sized to extend a length shorter than a length of the sidewalls 122. The rib 130 may be shaped similarly to the shape of the sidewalls 122. For example, in embodiments where the sidewalls 122 are rounded or annularly shaped, the rib 130 may be rounded or annularly shaped so that the sidewalls 122 concentrically surround the rib 130. The rib 130 may be configured to abut the protrusion 132 of the electronic tracking device 116 when the electronic tracking device 116 is received within the base cavity 124. As such, it should be appreciated that the rib 130 and the protrusion 132 may be similarly shaped. However. it is contemplated that the sidewalls 122 and the rib 130 of the base 118 may be shaped to receive a non-circular electronic tracking device. For example, the sidewalls 122 and the rib 130 of the base 118 may be rectangular to receive a rectangular electronic tracking device.

In some embodiments, the outer surface 129 of the rear wall 120 and/or the outer surface 127 of the sidewalls 122 may be a smooth surface with no or a limited amount of texture. This may be due to the base 118 being formed of a molded material, such as a polymer. In other embodiments, the base 118 is formed from glass, metal, resilient materials, such as, for example, rubber, soft plastic, and/or the like. However, it is contemplated and possible that the outer surface 129 of the rear wall 120 may have a textured surface to improve a grip or frictional force when a user grips the outer surface 129 of the rear wall 120.

Further, in some embodiments, the base 118, or portions thereof, is opaque in color. That is, the color of the base 118 may prevent visibility of the electronic tracking device 116 through the base 118. Further, the base 118 may be customizable into a plurality of colors or shades. In other embodiments, the base 118, or portions thereof, is transparent. That is, the color of the base 118 may allow or permit visibility of the electronic tracking device 116 through the base 118 so that indicia 146, 148 located on the electronic tracking device 116 may be visible through the base 118.

Referring still to FIGS. 1-3, the cap 119 of the case 110 may include a front member 134, one or more sidewalls 136 that extend transversely from the front member 134 to define a cap cavity 138, and a channel 154. The front member 134 may include a flange 152, an inner surface 158a, and an outer surface 158b opposite the inner surface 158a. The one or more sidewalls 136 may extend from the inner surface 158a of the front member 134 so that the inner surface 158a faces the cap cavity 138 to at least partially define the cap cavity 138. The inner surface 158a may be contoured so that when the electronic tracking device 116 is positioned in the case 110, the inner surface 158a is spaced apart from the first side 144a of the electronic tracking device 116 to define an acoustic chamber 162. The acoustic chamber 162 may amplify or prevent a reduction in sound generated by the electronic tracking device 116 when the electronic tracking device 116 is positioned within the case 110.

The one or more sidewalls 136 may include an outer surface 140 that includes external threads 142. The external threads 142 may circumferential surround at least a portion of the outer surface 140 of the one or more sidewalls 136 and be configured to mate with the internal threads 126 to couple the cap 119 to the base 118. The flange 152 may extend outward of the sidewalls 136 to define an overhang of the front member 134 with respect to the one or more sidewalls 136 that extend transversely from the front member 134.

The channel 154 may circumferentially surround the outer surface 140 of the one or more sidewalls 136 to be positioned between the external threads 142 and the flange 152. That is, the channel 154 may be positioned at the transition portion between where the one or more sidewalls 136 extend transversely from the front member 134 and is positioned between the external threads 142 and the flange 152. The channel 154 may be shaped similarly to the shape of the sidewalls 136 and the front member 134 such that the channel 154 may extend entirely around the outer surface 140 of the sidewalls 136. For example, the channel 154 may be round or annular in shape.

The channel 154 may be configured to receive the sealing member 156. However, it is contemplated and possible that the sealing member 156 may be provided anywhere within the base 118 and/or cap 119. For example, as will be described in further detail herein, the case 110 may include a plurality of sealing members disposed between the cap 119 and the base 118, and/or the cap 119 and the electronic tracking device 116. In some embodiments, the sealing member 156 may be formed of a silicone material. As such, the sealing member 156 may be an O-ring. In other embodiments, the sealing member 156 may be formed of a rubber material, a liquid material, a tape, a paste, or the like.

In some embodiments, the outer surface 158b of the front member 134 may be a smooth surface. That is, the outer surface 158b may have no or a limited amount of texture similar to the outer surface 129 of the rear wall 120 of the base 118. This may be due to the front member 134 being formed of a molded material, such as a polymer. In other embodiments, the front member 134 is formed from glass, metal, resilient materials, such as, for example, rubber, soft plastic, and/or the like. However, it is contemplated and possible that the outer surface 158b of the front member 134 may have a textured surface to improve a grip or frictional force when a user grips the outer surface 158b of the front member 134.

Further, in some embodiments, the front member 134, or portions thereof, is opaque in color. That is, the color of the front member 134 may prevent visibility of the electronic tracking device 116 through the front member 134. Further, the front member 134 may be customizable into a plurality of colors or shades. In other embodiments, the front member 134. or portions thereof, is transparent. That is, the color of the front member 134 may allow or permit visibility of the electronic tracking device 116 through the front member 134 so that indicia 146, 148 located on the electronic tracking device 116 may be visible through the front member 134.

As such, it should be appreciated that, in the aspects described with respect to FIGS. 1-3, the front member 134 is a protective cover that encloses the electronic tracking device 116 when the electronic tracking device 116 is positioned within the case 110 and the cap 119 is positioned in a secured position, as discussed in greater detail herein.

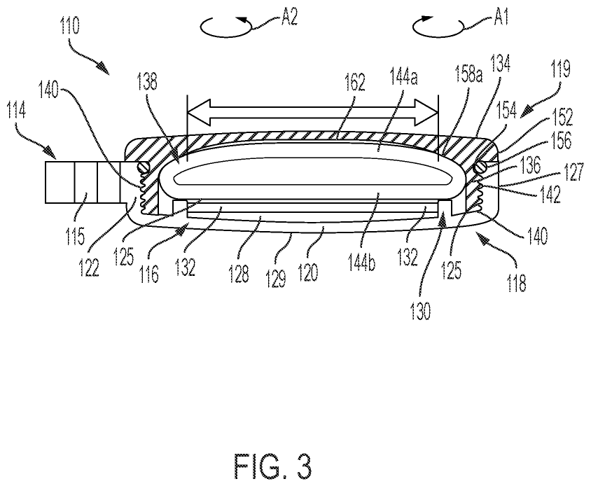

Referring to FIG. 3, the cap 119 may be releasably coupled to the base 118 via engagement between the internal threads 126 and the external threads 142. The external threads 142 of the cap 119 may be complementary to the internal threads 126 of the base 118 so that the external threads 142 of the cap 119 may be engaged or disengaged with the internal threads 126 of the base 118. Upon rotation of the cap 119 in the clockwise direction relative to the base 118, as illustrated by the arrow in the A1 direction, the cap 119 rotates to engage the external threads 142 of the cap 119 with the internal threads 126 of the base 118 such that the external threads 142 of the cap 119 are threaded onto the internal threads 126 of the base 118. As such, the cap 119 forms a secure connection with the base 118 to couple the cap 119 to the base 118. Further, in the secured position, at least a portion of the electronic tracking device 116 may be received within the cap cavity 138 and the base cavity 124, as discussed in greater detail herein.

When the cap 119 is rotated in a counter-clockwise direction, as illustrated by the arrow in the A2 direction, the cap 119 rotates to disengage the external threads 142 of the cap 119 with the internal threads 126 of the base 118 such that the external threads 142 of the cap 119 are unthreaded from the internal threads 126 of the base 118. As such, the cap 119 is released from the base 118, into an unlocked positon, and where access to the base cavity 124 and the cap cavity 138 is permitted to allow the electronic tracking device 116 to be positioned within or removed from the case 110. While the depicted case 110 is closed by rotating the cap 119 in the clockwise direction, it is contemplated and possible that the external threads 142 of the cap 119 may engage with the internal threads 126 of the base 118 to move the case 110 into the secured position when the cap 119 is rotated in the counter-clockwise direction.

When in the secured position, the sealing member 156 is compressed between the outer surface 140 of the sidewalls 136 and the flange 152 of the cap 119, and the inner surface 125 of the sidewalls 122 of the base 118 such that a seal is formed between the cap 119 and the base 118. The sealing member 156 creates a fluid tight seal (e.g., a watertight seal and/or an airtight seal) between the cap 119 and the base 118 to prevent ingress or egress of liquid, dirt, or other debris, into the base cavity 124 and/or the cap cavity 138 of the case 110, thereby protecting the electronic tracking device 116 when positioned within the base cavity 124 and/or the cap cavity 138 from contact with liquid, dirt, or debris.

The described case 110 provides IP68 waterproofing, capable of withstanding dust, dirt, sand, and fluid, such as water. The attachment between the cap 119 and the base 118 allows the electronic tracking device 116 to be easily accessible by twisting the cap 119 off of the base 118. Additionally, the attachment between the cap 119 and the base 118 provides a secure, tight fit. The attachment mechanism is versatile to allow the electronic tracking device 116 to be attached to any item, as described above, and in various manners. The case 110 provides protection to the electronic tracking device 116, while allowing the electronic tracking device 116 to be visible. Additionally, the case 110 allows for audio produced by the electronic tracking device to remain clear, without interfering with signals sent or received by the electronic tracking device.

In some embodiments, the case 110 may also include one or more surfaces having an aperture, openings, different materials, membranes, or the like for improving sound transmission of the electronic tracking device 116 through the cap 119 and/or the base 118.

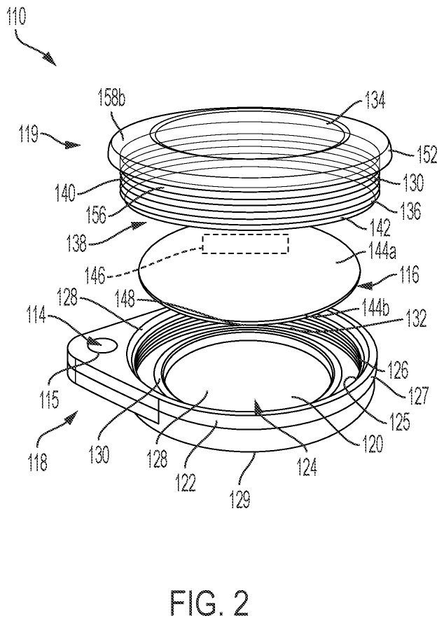

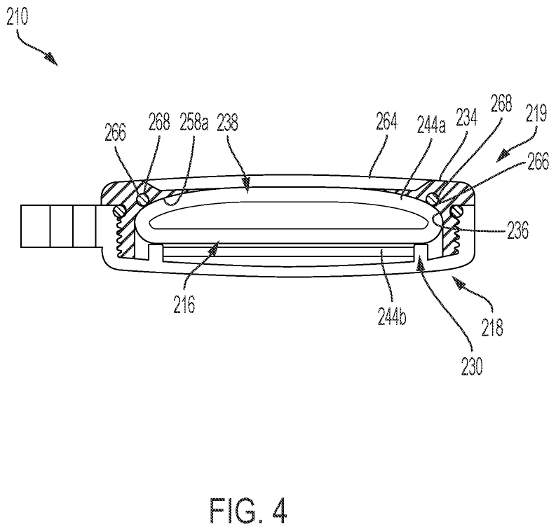

With reference to FIG. 4, an alternative cap 219 for a case 210 is depicted. It is understood that the case 210 is similar to the case 110 with the exceptions of the features described herein. As such, like features will use the same reference numerals with a prefix “2” for the reference numbers. As such, for brevity reasons, these features will not be described again. The alternative cap 219 may include an aperture 264 extending through the front member 234 of the cap 219. That is, the aperture 264 may extend through the cap 219 to extend into the cap cavity 238. The aperture 264 may be sized such that in the secured positon, a portion of the first side 244a of the electronic tracking device 216 is positioned within and supported by the aperture 264. As such, the indicia 146 (FIG. 2) may be visible through the aperture 264. It should be appreciated that the aperture 264 provides an unobstructed view of the indicia 146. The aperture 264 may permit sound generated from the electronic tracking device 216 to travel through the aperture 264 unobstructed by the structure of the cap 219. While the aperture 264 of the depicted case 210 is formed in the cap 219, it is contemplated and possible that the aperture 264 is additionally or alternatively formed in the base 218.

The cap 219 may further include a second channel 266 circumferentially surrounding the inner surface 258a of the front member 234 at the aperture 264. That is, the second channel 266 may be positioned at the transition portion between where the one or more sidewalls 236 extending transversely from the front member 234. The alternative cap 219 may include a second sealing member 268 that the second channel 266 is configured to receive. The second sealing member 268 may be positioned in the second channel 266 to form a seal between the electronic tracking device 216 and the cap 219 at the aperture 264. In some embodiments, the second sealing member 268 may be formed of a silicone material. As such, the sealing member may be an O-ring. In other embodiments, the second sealing member 268 may be formed of a rubber material, a liquid material, a tape, a paste, or the like.

In the secured position, the second sealing member 268 may be compressed between the first side 244a of the electronic tracking device 216 and the front member 234 of the cap 219 around the aperture 264 such that the second sealing member 268 forms a seal between the aperture 264 of the cap 219 and the first side 244a of the electronic tracking device 216.

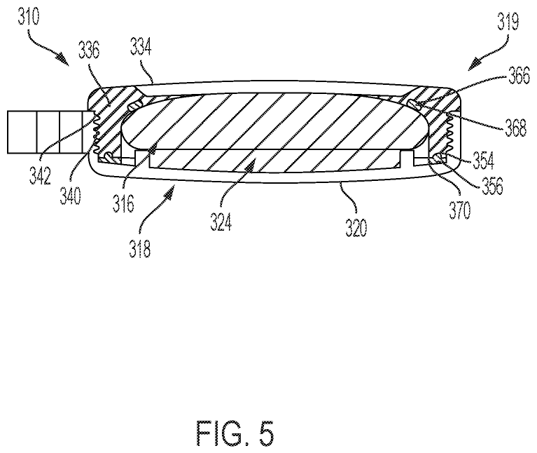

Now referring to FIG. 5, a third aspect of a case 310 is schematically depicted. It is understood that the case 310 may be substantially similar to either the case 110 or the case 210 with the exceptions of the features described herein. As such, like features will use the same reference numerals with a prefix “3” for the reference numbers. As such, for brevity reasons. these features will not be described again.

In the third aspect of the case 310, the cap 319 includes a channel 354 that circumferentially surrounds the outer surface 340 of the one or more sidewalls 336 at a terminating surface 370 of the one or more sidewalls 336 below the external threads 342 such that the external threads 342 are positioned between the channel 354 and the front member 334. As such, in the secured position, the channel 354 is positioned to be in contact with the rear wall 320 so that when the channel 354 receives the sealing member 356, the sealing member 356 is compressed between the rear wall 320 of the base 318 and the terminating surface 370 of the sidewalls 336 of the cap 319.

In the secured position, the first sealing member 356 may be in contact with and compressed by the rear wall 320 to form a fluid tight seal (e.g., a watertight seal and/or an airtight seal) to prevent ingress or egress of liquid, dirt, or other debris, into the base cavity 324 of the case 310, thereby protecting the electronic tracking device 316 within the base cavity 324 from contact with liquid, dirt, or debris.

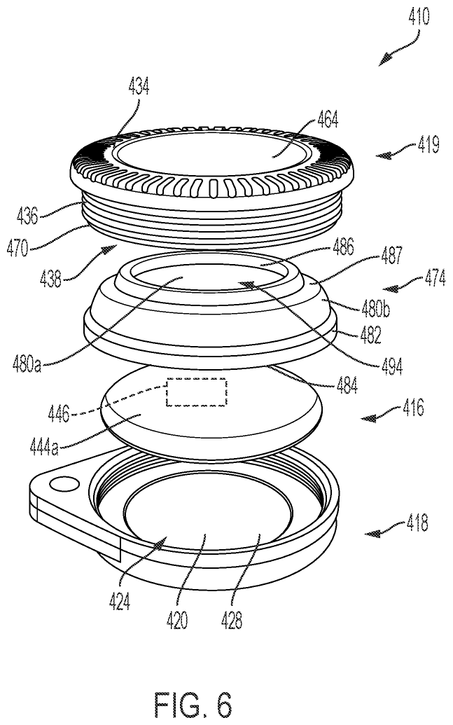

Now referring to FIG. 6, a fourth aspect of a case 410 is generally depicted. Similar to the second and third aspects, the fourth aspect of the case 410 may be substantially similar to any of the cases 110, 210, 310 with the exceptions of the features described herein. As such, like features will use the same reference numerals with a prefix “4” for the reference numbers. As such, for brevity reasons, these features will not be described again.

The case 410 may include a covering member 474 configured to receive the electronic tracking device 416. While the depicted case 410 does not include the sealing members discussed in the cases 110, 210. 310, it is contemplated and possible that the covering member 474 may be used in conjunction with the sealing members to form a seal in the case 410. The covering member 474 may be a generally frusto-conical shape with an interior surface 480a and an opposite exterior surface 480b. The covering member 474 may include a terminating flange 482 that is positioned at a base 484 of the covering member 474, an apex 486 that includes at least one raised portion 487 that assists aligning the covering member 474 with the aperture 464 defined by the front member 434 of the cap 419, and an opening 494 that extends through the interior surface 480a and the exterior surface 480b. The opening 494 of the covering member 474 may be positioned to be aligned with the aperture 464 in the cap 419 to provide an unobstructed view of the indicia 146 of the first side 144a of the electronic tracking device 116. In other words, the aperture 464 of the cap 419 may be positioned to be concentric with the opening 494 of the covering member 474. In embodiments, the covering member 474 may not include an opening 494 so that the covering member 474 restricts ingress and egress of fluid or particulate through the aperture 464.

The raised portions 487 of the covering member 474 may contact the aperture 464 of the cap 419 to form a seal between the aperture 464 and each of the cap cavity 438 and the base cavity 424. The terminating flange 482 may contact the inner surface 428 of the rear wall 420, the terminating surface 470 of the sidewalls 436 of the cap 419, and the electronic tracking device 416 to seal the electronic tracking device 416 within the base cavity 424.

In some embodiments, the covering member 474 may be a silicone rubber sleeve. As such, the covering member 474 is a resilient material that can be deformable to complement the contours of the electronic tracking device 416 and the aperture 464 of the cap 419. Further, in some embodiments, the covering member 474, or portions thereof, may be opaque in color. That is, the color of the covering member 474 my prevent visibility of the electronic tracking device 416 through the base 418. In other embodiments, the covering member 474, or portions thereof. is transparent. That is, the color of the covering member 474 may allow or permit visibility of the electronic tracking device 416 through the covering member 474. That is, in the secured position. in embodiments, the indicia 446 of the first side 444a of the electronic tracking device 416 may be visible through the covering member 474. Further, the covering member 474 may be customizable into a plurality of colors or shades.

In the above-described cases 110, 210, 310, 410, the attachment portions, such as the attachment portion 114, are depicted as an aperture for receiving an external attachment member to couple the case 110, 210, 310, 410 to an external object or surface. However, various embodiments of the case may include alternative attachment portions for coupling the case to external objects or surfaces in different manners.

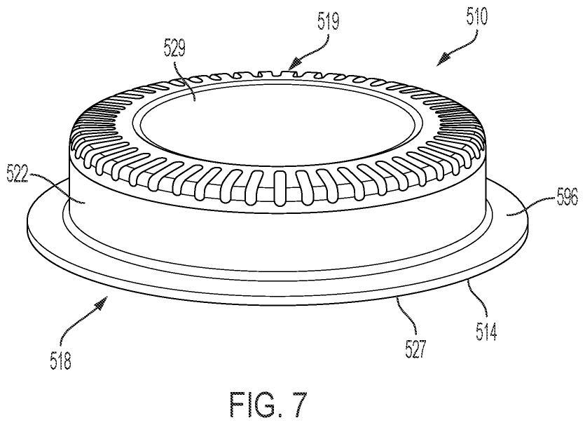

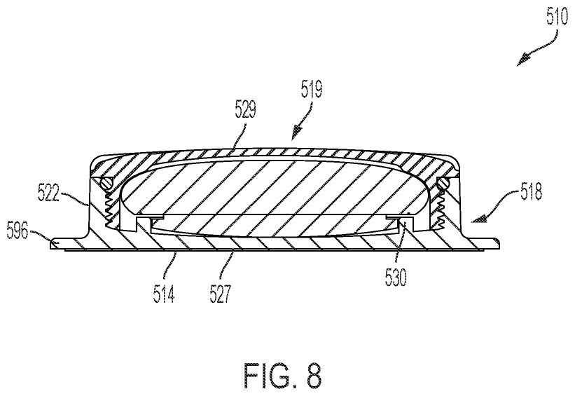

For example, FIGS. 7 and 8 depict a case 510 having an attachment element 514 for attaching the case 510 to an external surface or object. The case 510 may include substantially the same structure as the above-described cases 110, 210, 310, 410, with the exceptions of the features described herein. As such, like features will use the same reference numerals with a prefix “5” for the reference numbers. As such, for brevity reasons, these features will not be described again.

The attachment element 514 may be configured to be attached or coupled to the outer surface of the base 518 of the case 510. The attachment element 514 may include a layer of adhesive. For example, in embodiments, the attachment element 514 is a layer of double-sided adhesive tape for attaching the case 510 to an external surface of an item. It should be appreciated that alternative attachment elements may be disposed on the outer surface 527. For example, in embodiments, the base 518 includes one or more magnets embedded therein to facilitate magnetic connection to an item via the outer surface 527. In embodiments, one or more straps may extend from the base 518 to facilitate attachment of the base 518 to an item. The attachment member may be any suitable mechanical attachment element (e.g., clip, clasp, strap, adhering element such as Velcro®). Moreover, attachment elements may be disposed at locations other than the outer surface 527, such as, for example, on the sidewalls 522 or the outer surface 529 of the cap 519. For example, the base 518 may be attached to a vehicle. In embodiments, the cap 519 may include an attachment element to facilitate attachment to an external item or surface.

The base 518 of the case 510 may include an outer flange 596 that extends transversely from the sidewalls 522 so that the sidewalls 522 are positioned between the outer flange 596 and the rib 530. The outer flange 596 may increase the surface area of the outer surface 527 of the base 518. The increased surface area of the outer surface 527 allows for a larger or increased amount of attachment elements 514 to be attached to the base 518, thereby increasing a coupling force between the case 510 and the external object. For example, in embodiments where the attachment element 514 is one or more magnets, a larger magnet or additional magnets may be attached to the base 518 to increase the magnetic force from the attachment element 514.

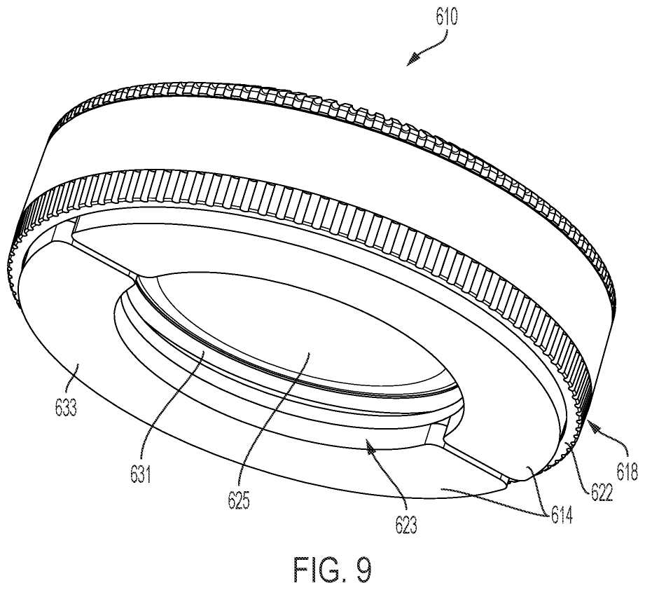

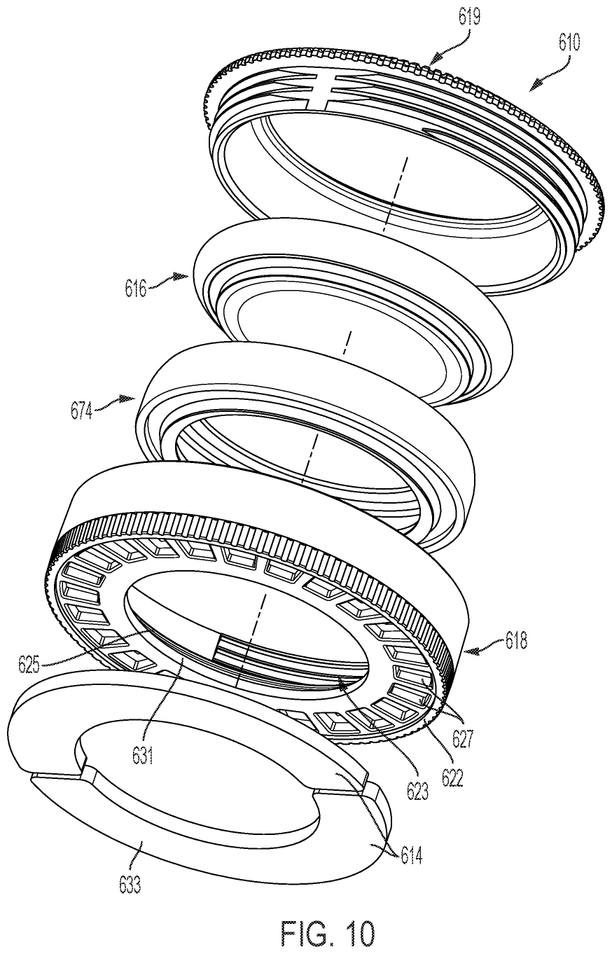

In further embodiments and with reference to FIGS. 9 and 10, a case 610 for an electronic tracking device 616 is depicted. The case 610 may include substantially the same structure as the above-described case 110, including a sleeve 674 and a cap 619, with the exceptions of the features described herein. As such, like features will use the same reference numerals with a prefix “6” for the reference numbers. As such, for brevity reasons, these features will not be described again.

The base 618 may include a cavity 623 formed in the outer surface 622 of the base 618 that is configured to receive one or more attachment members 614, and an inner cavity surface 625. The inner cavity surface 625 may be transparent to allow the electronic tracking device 116 to be visible through the inner cavity surface 625, as described in previous embodiments. In embodiments, the inner cavity surface 625 may include a bore 631 extending therethrough such that a portion of the electronic tracking device 116 is exposed through the base 618. The inner cavity surface 625 may include a plurality of depressions 627 formed therein to reduce the surface area contacted and coupled to the attachment member 614 to reduce a force required to remove the attachment member 614 from the base 618. The cavity 623 and the attachment member 614 may be sized and positioned in the cavity 623 such that an attachment surface 633 of the attachment member 614 is planar with the outer surface 622 of the base 618. In embodiments, the attachment member 614 may be segmented, such that the attachment member 614 includes two or more separate attachment members 614.

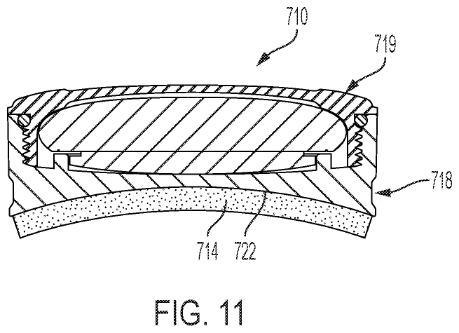

In further alternative embodiments and with reference to FIG. 11, an alternative case 710 is depicted. The case 710 may be substantially similar to the case 110 described above, and like structure will not be described again for brevity. As such, like features will use the same reference numerals with a prefix “7” for the reference numbers.

The case 710 may include a cap 719 and a base 718 that is structured to be attached. connected, or otherwise adhered to an external curved service (e.g., associated with an item having a location that a user desires to maintain knowledge of). The outer surface 722 of the base 718 may be non-planar so that the outer surface 722 may be contoured to a surface of an external object. The outer surface 722 may be, for example, curved so that the outer surface 722 may be contoured to a cylindrical surface. However, it is contemplated and possible that the outer surface 722 may include any other noncoplanar shape for coupling to a surface of an external object, such as a pyramidal shape.

The attachment member 714 may be shaped to be complementary to the shape of the outer surface 722 so that the attachment member 714 may facilitate attachment between the base 718 and the external object. For example, in embodiments where the outer surface 722 is curved, the attachment member 714 may be similarly curved.

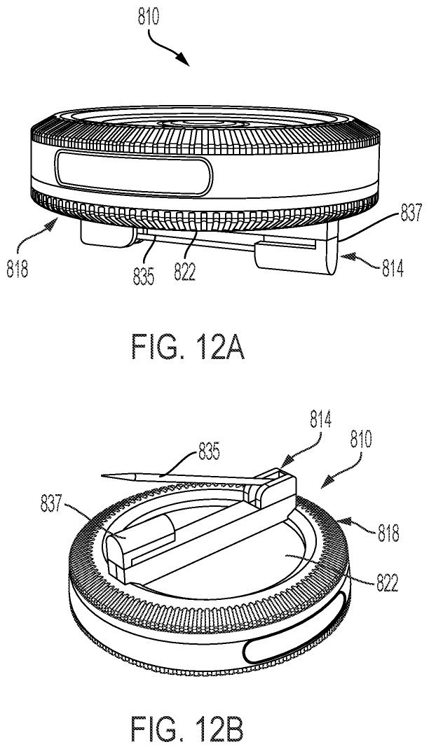

In some embodiments and with reference to FIGS. 12A and 12B, an alternative case 810 is depicted. The case 810 may be substantially similar to the case 110 described above. and like structure will not be described again for brevity. As such, like features will use the same reference numerals with a prefix “8” for the reference numbers.

The attachment portion 814 of the case 810 may be a pin assembly configured to couple the case 810 to fabric. The pin assembly may be a traditional pin, including a pin 835 and a clasp 837 configured to receive the pin 835. The pin 835 may be pivotally coupled to the outer surface 822 of the base 818 to pivot between an engaged position and a disengaged position. In the disengaged position, the pin 835 may be spaced apart from the clasp 837 to allow the pin 835 to pass through a fabric. Once the pin 835 is inserted through a fabric, the pin 835 may be rotated into the engaged position. In the engaged position, the pin 835 may be positioned in the clasp 837 to prevent the pin 835 from exiting the clasp 837. While the depicted pin assembly is depicted as a safety pin, the pin assembly may be any traditional pin assembly, such as, for example, a pin back that is removable from the pin to allow the pin to be inserted into a fabric.

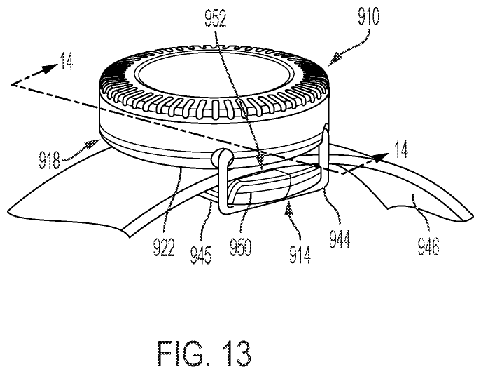

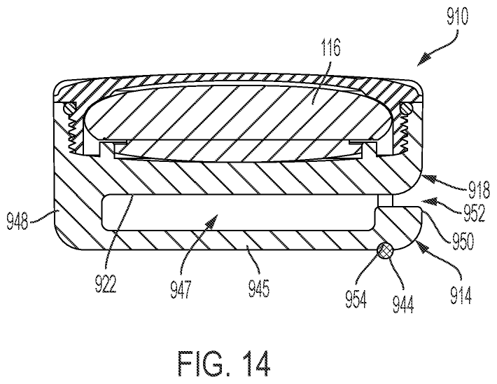

In embodiments and with reference to FIGS. 13-18, the attachment portion may be attachable to a strap, such as a watch strap. With reference to FIGS. 13 and 14, an alternative case 910 is depicted. The case 910 may be similar to the cases described above, such as the case 110. and like structure will not be described again for brevity. As such, like features will use the same reference numerals with a prefix “9” for the reference numbers. The attachment portion 914 may include an extension arm 945 that extends from the outer surface 922 of the base 918, and a securing member 944.

The extension arm 945 may be cantilevered from the outer surface 922 of the base 918 to be spaced apart from the outer surface 922 by a gap 947 into which an external item may be inserted. For example, as depicted in FIG. 13, a band structure 946 (e.g., a dog collar, a backpack strap, a watch band, a bracelet) may be routed between the extension arm 945 and the outer surface 922 of the base 918. This way, the electronic tracking device 116 may be used to track the location of an item to which the band structure 946 is attached (e.g., a pet, a child, another item). The structure of the base 918 adds to the functionality of the electronic tracking device 116 by facilitating its attachment to various external items. The attachment portion 914 may take any form to facilitate attachment of the electronic tracking device 116 to various items. In embodiments, the extension arm 945 may include a flexible band or a plurality of structures that are linked to one another to render the extension arm 945 flexible in shape to facilitate attachment of a variety of different items.

The extension arm 945 may include a first end 948 coupled to the outer surface 922 of the base 918 and a second end 950 opposite the first end 948. The extension arm 945 may define a slot 952 formed in the second end 950 of the extension arm 945 to allow the band structure 946 to be positioned in the gap 947 between the extension arm 945 and the outer surface 922 of the base 918, and a notch 954 formed in the extension arm 945 adjacent the second end 950 of the extension arm 945. The notch 954 may be formed adjacent the second end 950 of the extension arm 945 such that the slot 952 is positioned directly between the base 918 and the notch 954.

The securing member 944 may be hollow to allow the extension arm 945 to partially pass through the securing member 944 when the securing member 944 is positioned in the notch 954 of the extension arm 945. The securing member 944 may be pivotally coupled to the base 918 to move between an engaged position and a disengaged position. In the disengaged position, the securing member 944 may be spaced apart from the notch 954 to allow the band structure 946 to pass through the slot 952 in the extension arm 945. The securing member 944 may pivot from the disengaged position to the engaged position to be positioned in the notch 954 when in the engaged position. When the securing member 944 is in the engaged position, the securing member 944 may at least partially extend across the slot 952 in the extension arm 945 to prevent the band structure 946 from passing through the slot 952.

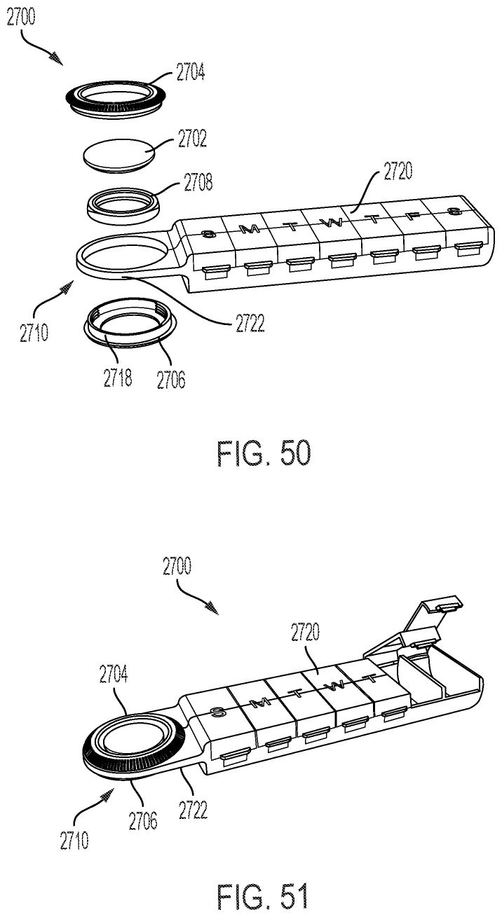

In some embodiments, the extension arm 945 may be shaped and/or sized to flex or temporarily deform around a detent or the like located on the base 918 such that the extension arm 945 is frictionally held to the base 918 when placed into the engaged position (e.g., snapped into place over the detent). It should be appreciated that, in such embodiments, the securing member 944 may be optional (e.g., may be omitted). Additional details will be described herein with respect to FIG. 50.

Still referring to FIGS. 13 and 14, in some embodiments, portions of the extension arm 945 and/or the base 918, particularly those that face one another when the extension arm 945 is in a closed position, may include surface features thereon. Such surface features may increase the surface area of contact when the extension arm 945 is placed around an object, thereby providing an increased frictional fit relative to components that do not include such surface features. It should be appreciated that the surface features may prevent sliding or movement (e.g., on a strap or the like) when the case 910 is placed in position on an object (e.g., the strap or the like).

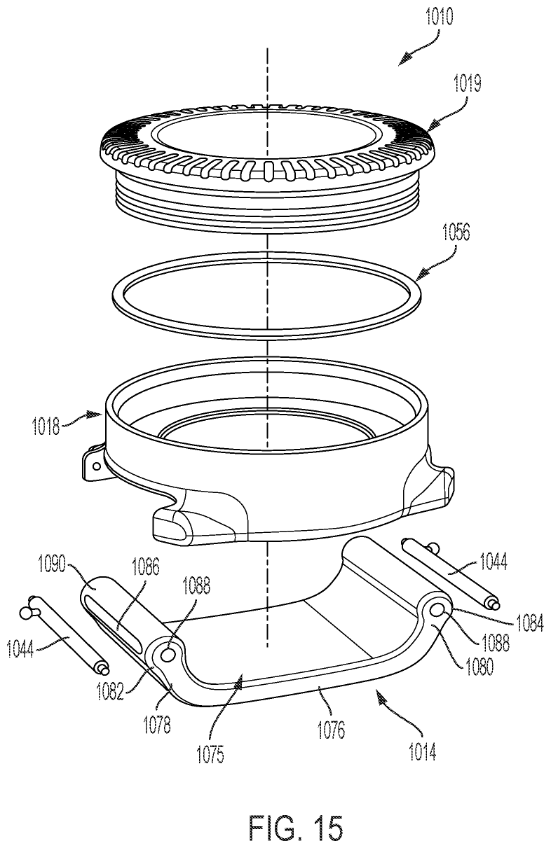

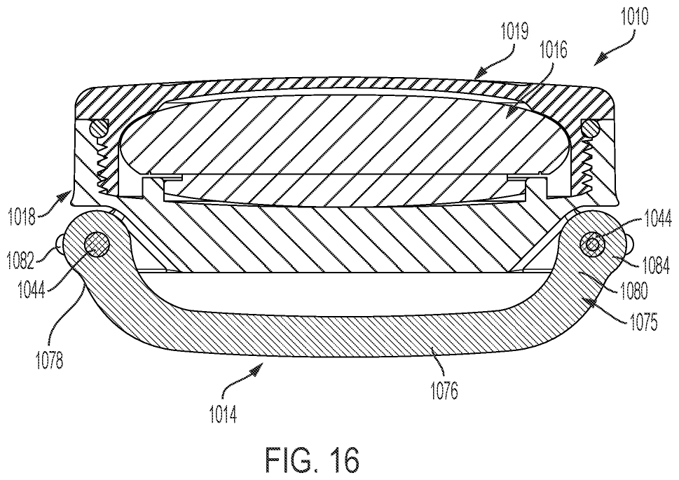

Referring now to FIGS. 15 and 16, another case 1010 including an alternative attachment portion 1014 is depicted. The case 1010 may be similar to the cases described above. such as the case 910, and like structure (for example, the cap 1019, the sealing member 1056, and the electronic tracking device 1016) will not be described again for brevity. As such, like features will use the same reference numerals with a prefix “10” for the reference numbers.

The attachment portion 1014 may include a collar 1075 that is selectively coupled to the base 1018 via a pair of securing members 1044. The pair of securing members 1044 may be conventional watch band pins that include a handle and a protrusion that extends into complementary holes in the base 1018 to allow the pair of securing members 1044 to selectively engage the base 1018. The collar 1075 may include an elongated body 1076 having a first end 1078 and an opposite second end 1080, a first attachment portion 1082 at the first end 1078 of the elongated body 1076, and a second attachment portion 1084 at the second end 1080 of the elongated body 1076. The collar 1075 may be curved so that the collar 1075 extends away from the base 1018 as the elongated body 1076 extends away from the attachment portions 1082, 1084.

Each of the first attachment portion 1082 and the second attachment portion 1084 may define a slot 1086, and a bore 1088 extending therethrough configured to receive one of the pair of securing members 1044 to couple the first attachment portion 1082 to the base 1018. The slot 1086 may extend in parallel with the bore 1088 through an outer surface 1090 of the first attachment portion 1082 so that the handle of one of the securing members 1044 positioned in the bore 1088 extends out of the slot 1086.

One of the pair of securing members 1044 may be selectively disengaged with the base 1018 to allow the collar 1075 to rotate about the other of the pair of securing members 1044. and to allow for an external item to be positioned between the collar 1075 and the base 1018. The one of the pair of securing members 1044 may be reengaged with the base 1018, thereby coupling the case 1010 to the external item. For example, a band structure (e.g., a dog collar, a backpack strap, a watch band, a bracelet) similar to the band structure 946 described above, may be routed between the collar 1075 and the base 1018. This way, the electronic tracking device 116 may be used to track the location of an item to which the band structure is attached (e.g., a pet, a child. another item).

In embodiments, the pair of securing members 1044 is rotatably attached to the base 1018 via a suitable attachment mechanism. In the depicted embodiment, for example, at least a portion of the pair of securing members 1044 extends through openings (e.g., cavities, holes, or the like) in the base 1018. In embodiments, only one of the pair of securing members 1044 is selectively engagable with the base 1018, and the other of the pair of securing members 1044 is rotatably coupled to the base 1018.

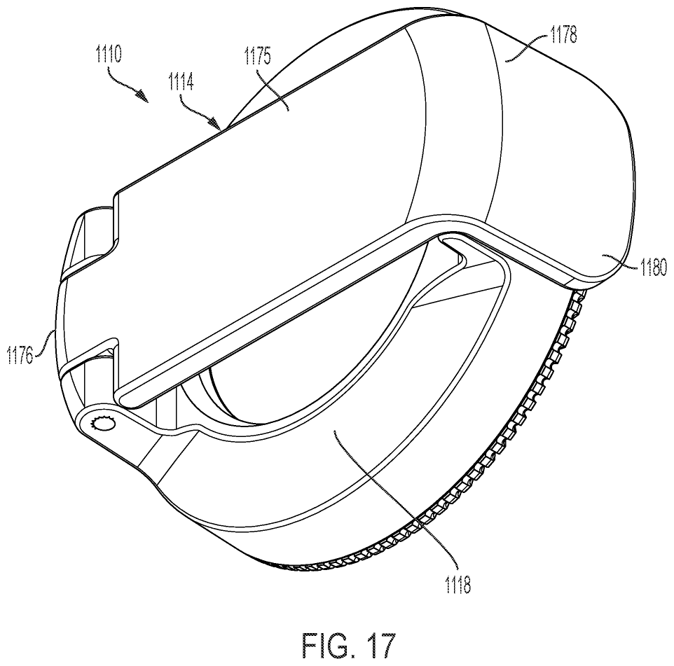

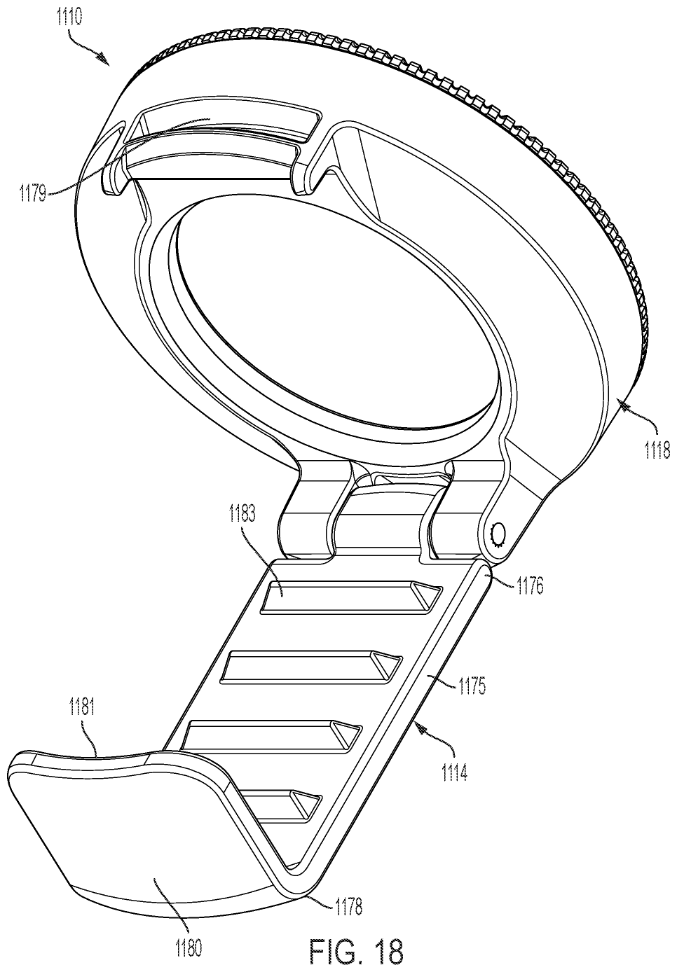

In embodiments and with reference to FIGS. 17 and 18, another case 1110 having an alternative attachment portion 1114 is depicted. The alternative attachment portion 1114 may include a collar 1175 having a first end 1176 and an opposite second end 1178. The first end 1176 of the collar 1175 may be pivotally coupled to the base 1118. The second end 1178 of the collar 1175 may include an attachment portion 1180 that extends from the second end 1178 of the collar 1175 to selectively couple to the base 1118. The attachment portion 1180 may include an inner surface 1181 facing the first end 1176 configured to engage with a portion of the base 1118 to retain the attachment portion 1180 against the base 1118. The inner surface 1181 may include a catch (not shown) or other feature extending therefrom for engaging with the base 1118.

The base 1118 may define a receiving notch 1179 configured to receive the attachment portion 1180 of the collar 1175 to selectively couple the second end 1178 of the collar 1175 to the base 1118. The collar 1175 may additionally include a plurality of surface features 1183 (e.g., ridges) extending from the collar 1175 toward the base 1118, the surface features 1183 being configured to increase the grip between the base 1118 and an external structure, such as the band structure 946 of FIG. 13.

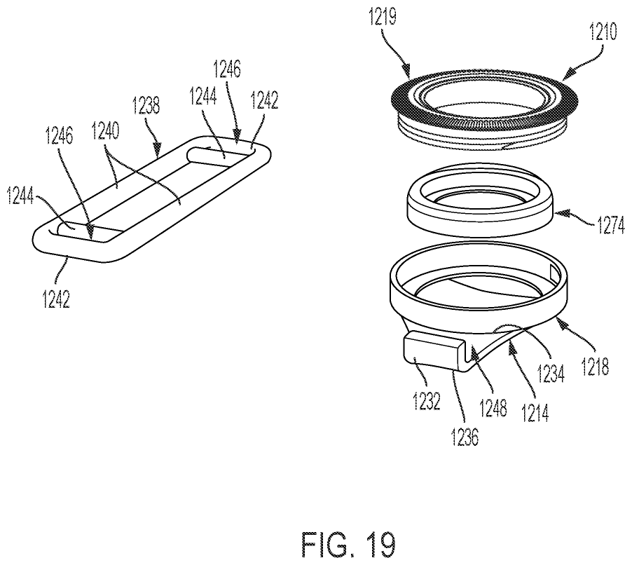

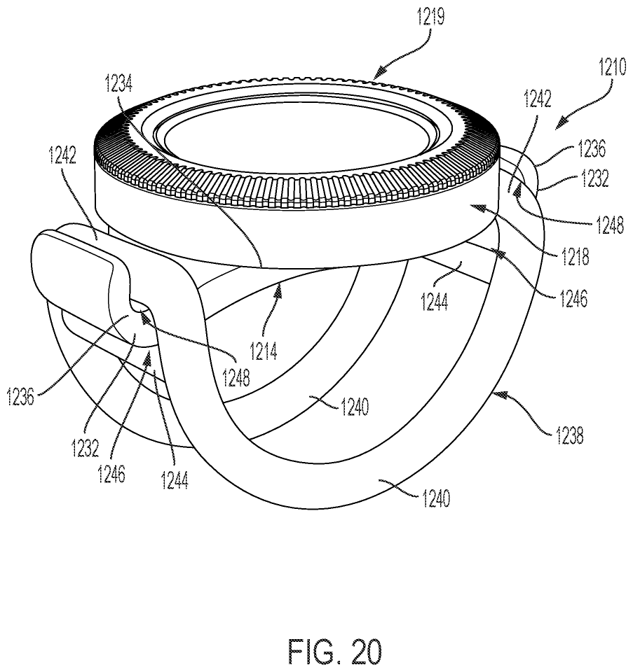

Referring now to FIGS. 19 and 20, another case 1210 having an alternative attachment portion 1214 is generally depicted. The case 1210 may be similar to the cases described above, such as the case 910, and like structure will not be described again for brevity. As such, like features will use the same reference numerals with a prefix “12” for the reference numbers. For example, the case 1210 may include a cap 1219, a base 1218, and a sleeve 1274 similar to those described above.

The attachment portion 1214 may include a pair of groove members 1232 extending from the base 1218 in opposing directions, and a band 1238. The pair of groove members 1232 may each include a first end 1234 coupled to the base 1218, and an opposite second end 1236. The second end 1236 of the pair of groove members 1232 may be curved or angled toward the cap 1219 to define a channel 1248 configured to receive a portion of the band 1238.

The band 1238 may include a first pair of elongated members 1240 extending in parallel, a second pair of elongated members 1242 extending in parallel with one another, and a pair of mounting brackets 1244 extending in parallel with the second pair of elongated members 1242 between the first pair of elongated members 1240. The second pair of elongated members 1242 may extend perpendicularly from one of the first pair of elongated members 1240 and connects to the other of the first pair of elongated members 1240. The pair of mounting brackets 1244 may be positioned between the second pair of elongated members 1242. The band 1238 may be formed of a flexible material, such as rubber, silicone, or the like.

Referring to FIG. 20, the band 1238 may be selectively attached to the pair of groove members 1232 to couple the case 1210 to an external item. One of the pair of groove members 1232 may be positioned between one of the second pair of elongated members 1242 and one of the pair of mounting brackets 1244 to retain the band in the groove member 1232. The other of the pair of groove members 1232 may be positioned between the other of the second pair of elongated members 1242 and the other of the pair of mounting brackets 1244 to retain the band 1238 in the other groove member 1232. The second pair of elongated members 1242 are held between the base 1218 and the pair of groove members 1232 and may extend around an external object to couple the case 1218 to the external object. The second pair of elongated members 1242 may be press fit between the base 1218 and the pair of groove members 1232. When the pair of groove members 1232 are coupled to the band 1238, a mounting bore 1246 is defined by the band 1238, the pair of groove members 1232, and the base 1218. The external item may be positioned within the mounting bore 1246, thereby coupling the case 1218 to the external item. The band 1238 may be removed from the pair of groove members 1232 to decouple the case 1218 from the external item.

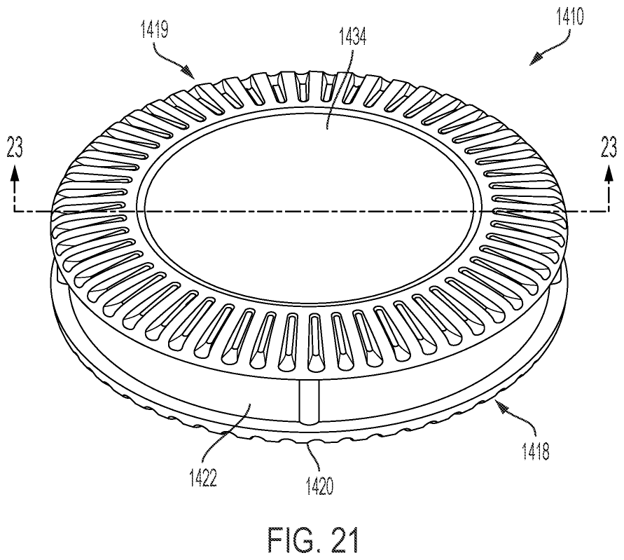

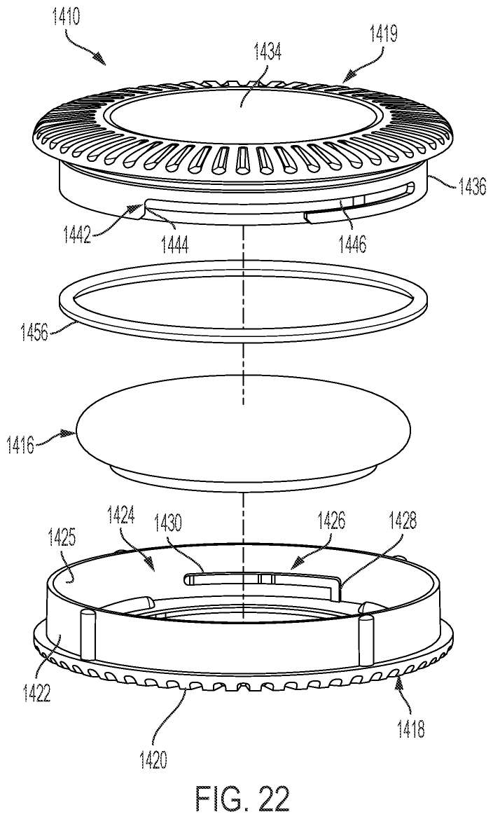

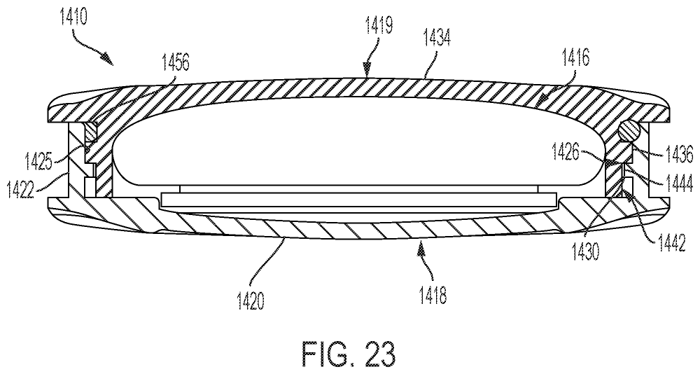

Referring now to FIGS. 21-23 schematically depict a case 1410 including an alternative coupling mechanism. The case 1410 may include substantially the same cap 1419, base 1418, scaling member 1456, and the attachment portion 1414 as the cap 119, the base 118, the sealing member 156, and the attachment portion 114 of the case 110 described above. The case 1410 may differ in that the alternative coupling mechanism may be a bayonet coupling for coupling the cap 1419 and the base 1418. Specifically, the base 1418 may include an engaging portion 1426 disposed within the base cavity 1424 and extending from the inner surface 1425 of the sidewall 1422. The cap 1419 may include a complementary engaging portion 1442 configured to mate with, engage, couple, or otherwise attach to the engaging portion 1426 of the base 1418.

The engaging portion 1426 of the base 1418 may be a male tuned slots and the engaging portion 1442 of the cap 1419 may be a female tuned slots or channels configured to receive the engaging portion 1426 of the base 1418. The engaging portion 1442 of the cap 1419 may include an entry groove 1444 and a locking groove 1446 that extends from the entry groove 1444. The locking groove 1446 may partially extend around the periphery of the sidewall 1422. The engaging portion 1426 of the base 1418 may include a first elongated body 1428 and a second elongated body 1430 extending from the first elongated body 1428. The first elongated body 1428 may extend transversely from the rear wall 1420 of the base 1418 along the sidewall 1422, and the second elongated body 1430 may extend transversely from the first elongated body 1428 to extend along the inner surface 1425 of the sidewall 1422. The second elongated body 1430 may have a length that is less than a length of the entry groove 1444 of the engaging portion 1442 of the cap 1419 so that the engaging portion 1426 of the base 1418 may be inserted into the engaging portion 1442 of the cap 1419. Once inserted into the engaging portion 1426 of the base 1418, the cap 1419 may be rotated to traverse the second elongated body 1430 of the engaging portion 1426 of the base 1418 along the locking groove 1446 to retain the cap 1419 to the base 1418.

It is further noted that the engaging portion 1426 and the engaging portion 1442 may be of any appropriate configuration and type, including, without limitation being a threaded portion, magnetic locks, channel locks, a bayonet engaging member, or other formations that can mate with each other. Moreover, the engaging portions 1426. 1442 may be of any appropriate shape, such as hook shaped, jig-saw shaped, or the like.

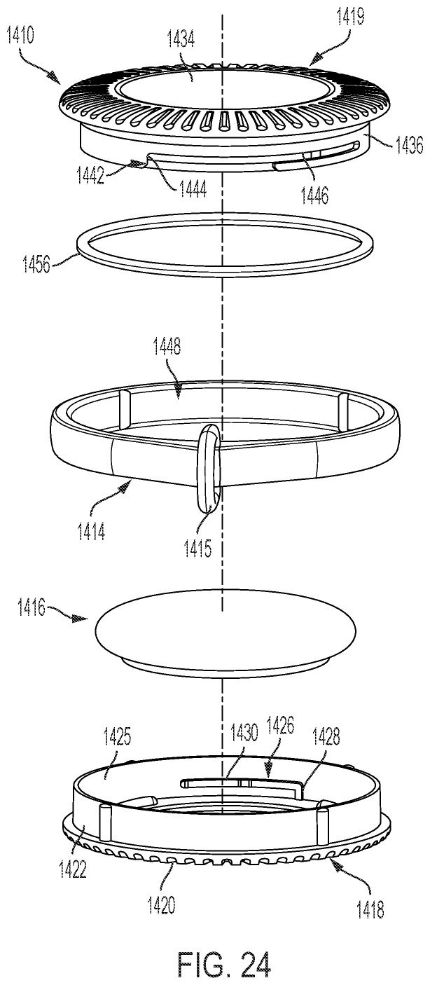

Referring briefly to FIG. 24, in embodiments, the case 1410 may further include an attachment portion 1414 with a ring-shaped body defining a cavity 1448 therein. The sidewall 1436 of the cap 1419 and the sidewall 1422 of the base 1418 may extend through the cavity 1448 of the attachment portion 1414 to retain the attachment portion 1414 when the cap 1419 is coupled to the base 1418. The attachment portion 1414 may include an attachment member 1415 for attaching to an external object. The attachment member 1415 may be any mechanism for attaching to an external object, such as a hoop.

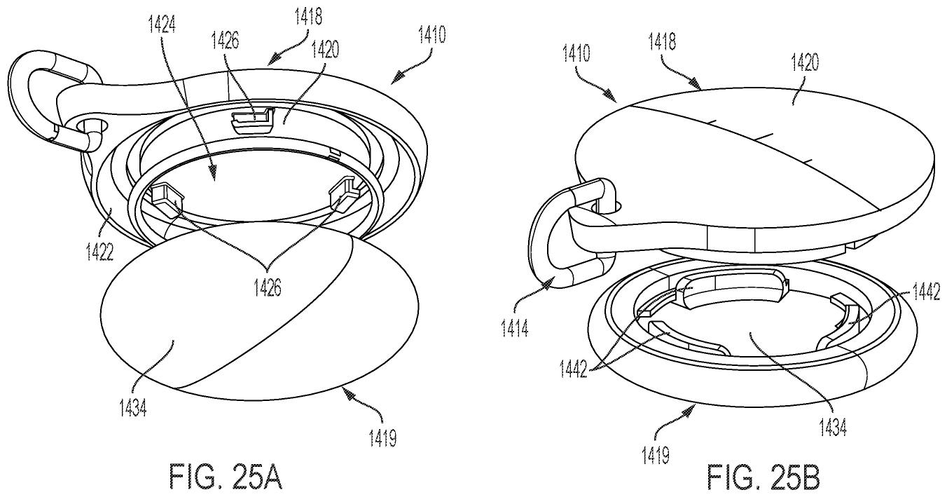

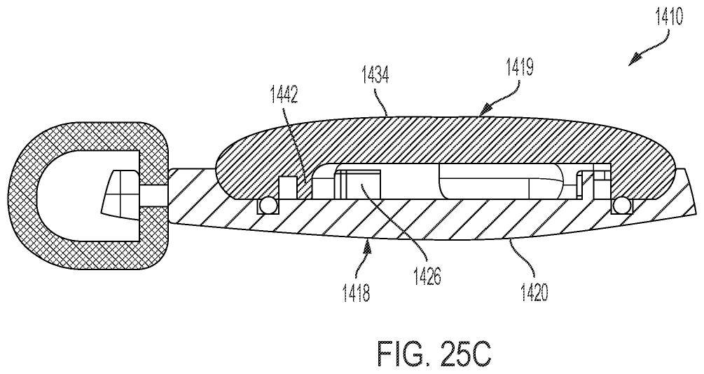

While the depicted case 1410 depicts the engaging portions 1426, 1442 extending from the sidewall 1422 of the base 1418 and the sidewall 1436 of the cap 1419, it is contemplated and possible that the engaging portions 1426, 1442 may be positioned elsewhere on the base 1418 and the cap 1419. For example and with reference to FIGS. 25A-C, in some embodiments, the engaging portion 1442 of the cap 1419 may extend from the front member 1434 toward the base 1418, and the engaging portion 1426 of the base 1418 may extend from the rear wall 1420 toward the cap 1419. The engaging portions 1426. 1442 may be sized and positioned to allow the electronic tracking device 116 to be positioned between the engaging portions 1426, 1442.

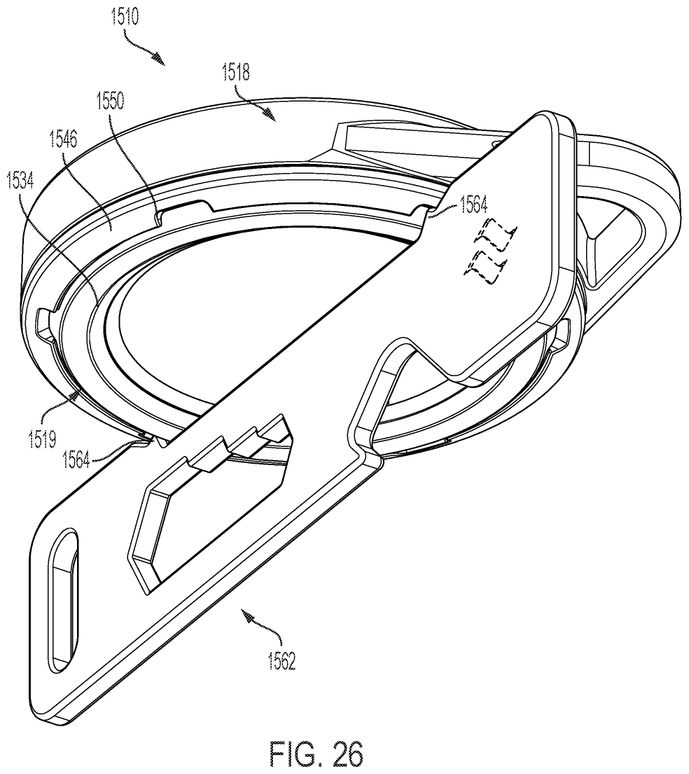

In further alternative embodiments and with reference to FIG. 26, a case 1510 may include an alternative cap 1519 may include a raised edge 1546 extending from the front member 1534 of the cap 1519, and a plurality of grooves 1550 formed in the raised edge 1546 of the cap 1519. The grooves 1550 may be keyed to be engaged by an external tool 1562 to allow the cap 1519 to be rotated relative to the base 1518, thereby disengaging the cap 1519 from the base 1518 to remove the electronic tracking device (not shown) from the case 1510.

The external tool 1562 may include a pair of ridges 1564 that extend from the external tool 1562. The pair of ridges 1564 may be spaced apart and sized to extend into and engage the grooves 1550 of the cap 1519. The pair of ridges 1564 may be positioned to engage the plurality of grooves 1550. In embodiments, the pair of ridges 1564 may be positioned to engage any pair of the plurality of grooves 1550. In other embodiments, the external tool 1562 may include a single ridge 1564 configured to extend into a single groove 1550 in the cap 1519. The cap 1519 may be selectively coupled to the base 1518 in a press-fit configuration, where the external tool 1562 may be used to pry the cap 1519 from the base 1518 by extending the ridge 1564 into the groove 1550, and rotating the external tool 1562 to rotate the cap 1519 away from the base 1518. The external tool 1562 may be a multi-tool including a plurality of functions and features, such as a bottle opener, a measurement tool, a hole configured to couple the external tool to an external object, or the like.

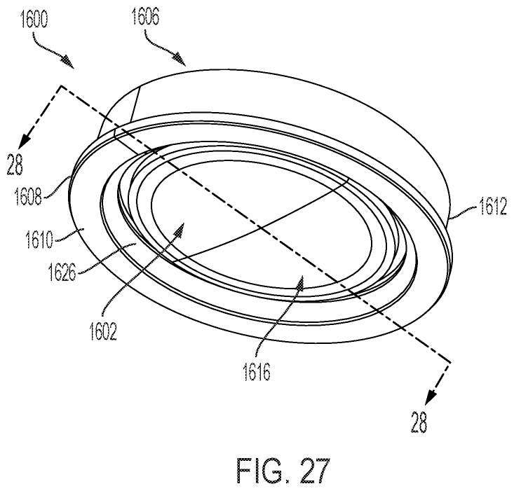

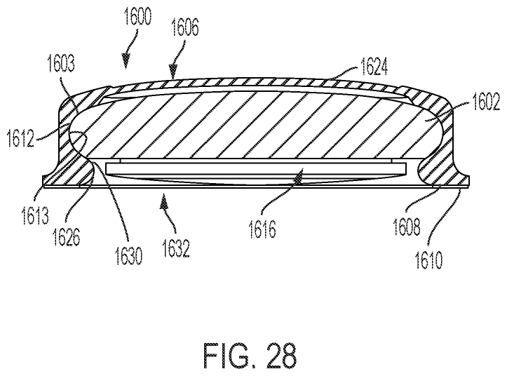

While the above described embodiments of the case depict a threaded connection between the cap and the base, additional embodiments described herein may include other manners of coupling the cap to the base. In the following embodiments, the cap may be coupled to the base by a deformable ridge, snap fit coupling. In some embodiments, the case may not include a base, where the cap alone encloses the electronic tracking device. For example, referring to FIGS. 27 and 28, in some embodiments, the case 1600 may include just a cap without a base. In embodiments, the cap 1606 is structured to house the electronic tracking device 116 and be attached, connected, or otherwise adhered to an external service (e.g., associated with an item having a location that a user desires to maintain knowledge of). The cap 1606 may include one or more attachment elements to facilitate connecting the cap 1606 with such an item, as detailed above.

The cap 1606 may include a rear surface 1608 and an attachment element 1610. The attachment element 1610 may include a layer of adhesive. For example, in embodiments, the attachment element 1610 is a layer of double-sided adhesive tape for attaching the case 1600 to an external surface of an item. It should be appreciated that alternative attachment elements may be disposed on the rear surface 1608. For example, in embodiments, the cap 1606 may include one or more magnets embedded therein to facilitate magnetic connection to an item via the rear surface 1608. Additionally, in embodiments, the alternative attachment elements may be any suitable mechanical attachment element (e.g., clip, clasp, strap, adhering element such as Velcro®, or the like). Moreover, attachment elements may be disposed at locations other than the rear surface 1608. The cap 1606 may be attached via the attachment element 1610 to, for example, a vehicle. In embodiments where the attachment element 1610 is a magnet, the cap 1606 may be magnetically coupled to a metal component of the vehicle. In embodiments where the attachment clement 1610 is an adhesive, the cap 1606 may be attached to a non-metal surface of the vehicle, such as a windshield.

The cap 1606 may define a device cavity 1616 in which an electronic tracking device 1602 is disposed, and an opening 1632 for inserting the electronic tracking device 1602 into the device cavity 1616. The cap 1606 may include at least one sidewall 1612, a cover portion 1624, and an engaging portion 1626 to facilitate retention of the electronic tracking device 1602 within the cap 1606. In embodiments, at least the cover portion 1624 of the cap 1606 is constructed of a suitable transparent material (e.g., plastic, or other suitable polymer-based material) to permit visibility of the electronic tracking device 1602 through the cover portion 1624. The sidewall 1612 may extend transversely from the cover portion 1624 around the device cavity 1616 and the opening 1632 so that the sidewall 1612 and the cover portion 1624 define the device cavity 1616. The engaging portion 1626 may extend from an inner surface 1613 of the sidewall 1612 toward the electronic tracking device 1602 at an angle to extend around a periphery 1603 of the electronic tracking device 1602.

In embodiments, the engaging portion 1626 includes one or more engaging features that contact the electronic tracking device 1602 to facilitate retention of the electronic tracking device 1602 within the device cavity 1616. For example, in embodiments, the engaging portion 1626 is an internal surface of the sidewalls 1612 of the cap 1606 that follows a contour of the periphery 1603 of the electronic tracking device 1602. Friction between the engaging portion 1626 and the electronic tracking device 1602 may facilitate retention of the electronic tracking device 1602 in the device cavity 1616. In embodiments, the cap 1606 is constructed of a suitable flexible material (e.g., a plastic or other suitable polymeric material) that is deformed prior the electronic tracking device 1602 being inserted into the cap 1606. The cap 1606 may be formed of a flexible material, such as rubber, soft plastic, an elastomer, or the like, such that the engaging portion 1626 of the cap 1606 may elastically deform. The engaging portion 1626 may be flexed to expand the device cavity 1616 such that the device cavity 1616 is larger than the electronic tracking device 1602 to facilitate positioning the electronic tracking device 1602 within the device cavity 1616 of the cap 1606. Similarly, the electronic tracking device 1602 may be pressed into the engaging portion 1626, deforming the engaging portion 1626 to allow the electronic tracking device 1602 to be positioned within the device cavity 1616. Once the electronic tracking device 1602 is disposed in the device cavity 1616, the cap 1606 may be released and apply a pressure to the electronic tracking device 1602. In embodiments, the engaging features of the engaging portion 1626 may include one or more hooks, an area of increased surface roughness, an adhesive layer, a magnet, or other structure configured to engage with the electronic tracking device 1602.

Referring to FIG. 28, in the depicted embodiment, the engaging portion 1626 may be an internal surface 1630 (e.g., delineating the boundary of the device cavity 1616 following a contour that conforms with at least a portion of the electronic tracking device 1602). For example. the engaging portion 1626 may conform with the periphery 1603 of the electronic tracking device 1602. The electronic tracking device 1602 may be retained within the device cavity 1616 via pressure applied by the internal surface 1630. In embodiments, the internal surface 1630 includes one or more retention features (e.g. magnets, adhesives, or the like) that engage with corresponding features on the electronic tracking device 1602 to facilitate retention of the electronic tracking device 1602 within the device cavity 1616.

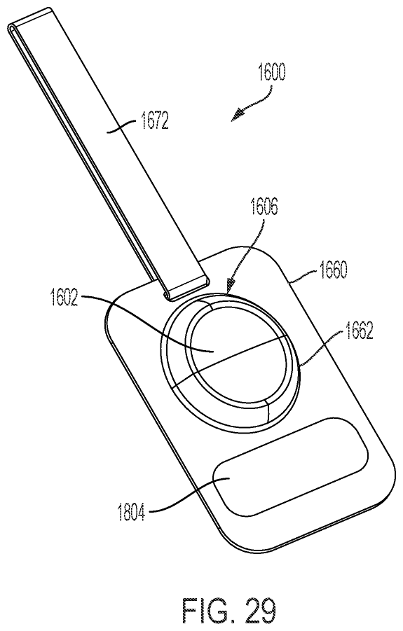

In some embodiments and with reference to FIG. 29, the cap 1606 may include a tag 1660 extending from a periphery 1662 of the cap 1606 so that the cap 1606 may operate as a luggage tag. The cap 1606 may include an attachment device 1672 that extends through the tag 1660 for attaching the cap 1606 to luggage.

In at least one embodiment, the tag 1660 may include a tamper resistant mechanism 1804 to prevent tampering and/or notify a user of an attempted or actual tampering. In examples. the tag 1660 may include a wireless device, such as sensors, a near field communication (NFC) tag, or the like. The NFC tag may be hermetically sealed within the tag 1660. The NFC tag may communicate with the electronic tracking device such that separation of the electronic tracking device from the tag 1660 may be monitored and may trigger an alert or alarm. The alert may be sent by the electronic tracking device to a user's device or may be an audible alert that may alert bystanders of tampering. As another example, a tamper resistant mechanism can include a pressure sensor. Reed switch, or other device that may trigger an alert or alarm, which may be generated by the electronic tracking device or by another device, such as an audio or visual device built into the tag 1660.

In other examples, a tamper resistant mechanism may include mechanical devices, chemical tampering devices, or the like. For instance, an adhesive may be applied to the tag 1660 and/or the electronic tracking device. The adhesive may be directly attached to the tag 1660 and/or electronic tracking device, or may be attached to a strip of material, such as a piece of tape. Removal of the electronic tracking device may break the adhesive bond, which indicates tampering.

In further embodiments and with reference to FIG. 30, the cap 1606 may include an extension 1674 at the periphery 1662 of the cap 1606 to increase a surface area of the cover portion 1624 to accommodate an increased size of an attachment member for coupling to an external device.

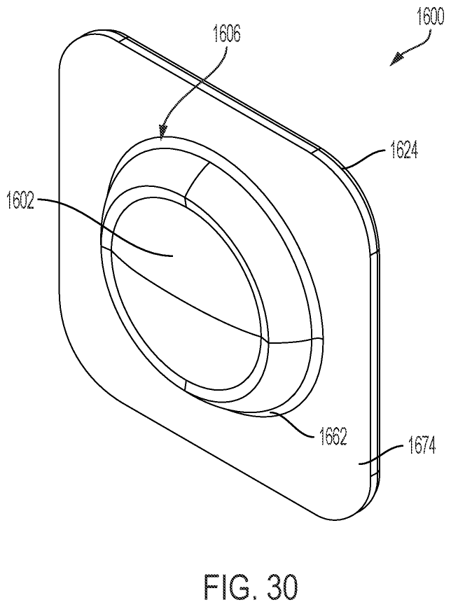

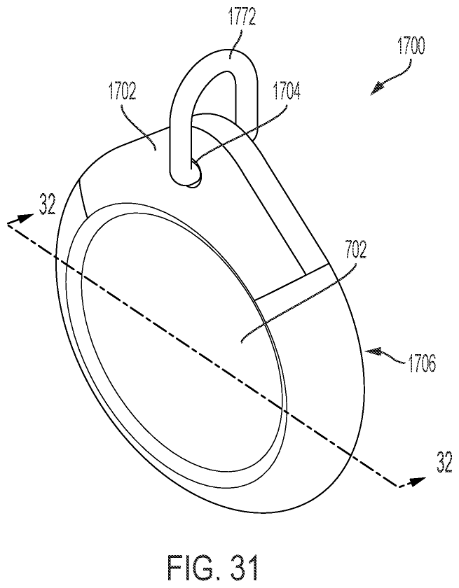

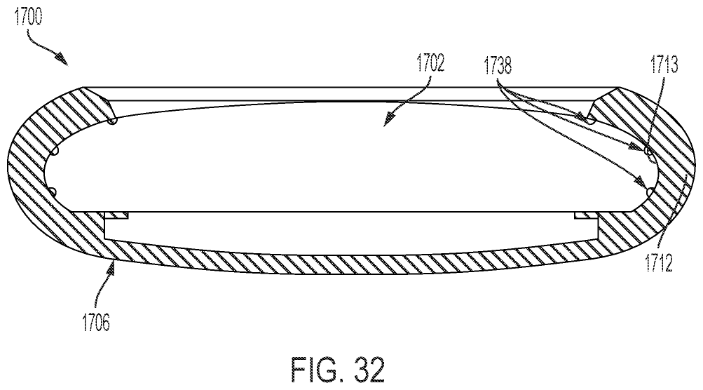

Referring now to FIGS. 31 and 32, another embodiment of a case 1700 is generally depicted. The case 1700 may be substantially similar to the case 1600 described above, and like structure will not be described again for brevity. As such, like features will use the same reference numerals with a prefix “17” for the reference numbers.

The case 1700 generally includes an attachment body 1702 on a periphery of the cap 1706. The attachment body 1702 may include a portion of material having one or more apertures 1704 formed within the portion. An attachment device 1772 may be disposed within or through the one or more apertures 1704. It is noted that the attachment body 1702 may include other appropriate mechanisms, such as magnetic connections, threaded members, channel locking mechanisms, or the like, for facilitating attachment to an external device. The attachment body may be similar to the attachment mechanisms described herein, such as, for example, a loop.

Still referring to FIGS. 31 and 32, the cap 1706 may include one or more sealing mechanisms 1738 projected or formed at or on the sidewall 1712. The sealing mechanisms 1738 may be a plurality of protrusions extending from the inner surface 1713 towards the electronic tracking device 702, when assembled, to be compressed against the electronic tracking device 702 to form a seal. The seal may prevent foreign material from passing around the electronic tracking device 702. It is noted that the sealing mechanisms 1738 may include a plurality or annular or ring shaped projections that may provide for a plurality of seals formed between the electronic tracking device 702.

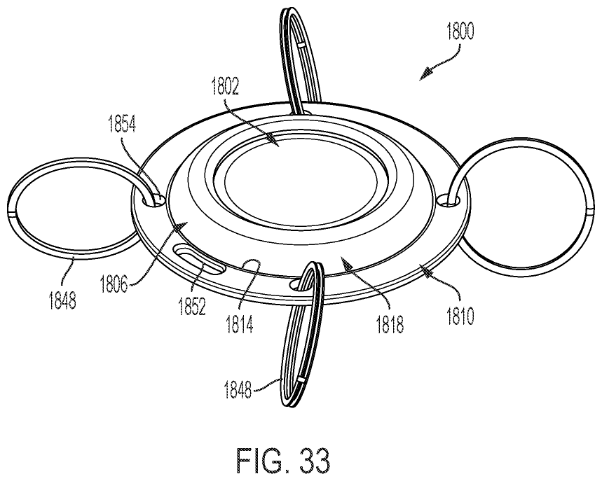

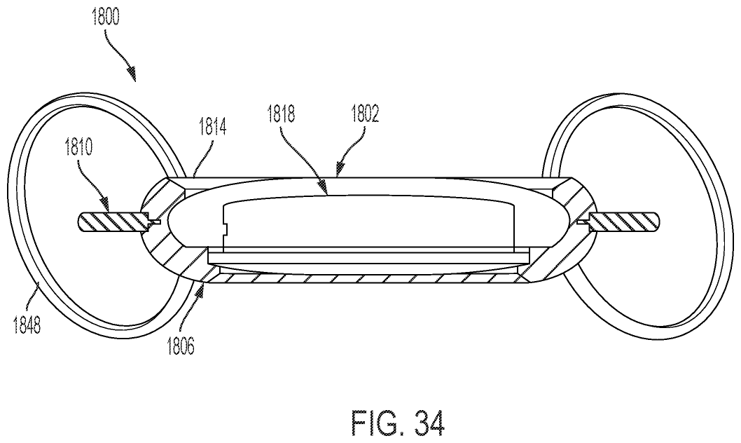

The embodiments described herein may include various manners of attaching the case to external objects. For example and with reference to FIGS. 33 and 34, an embodiment of a case 1800 for an electronic tracking device 1802 is generally depicted. The case 1800 may be substantially similar to the case 1700 described above, and like structure will not be described again for brevity.

The case 1800 may include an attachment body 1810 that includes an internal surface 1814 defining an opening 1818, and one or more apertures 1854, 1852, through which one or more attachment devices 1848 may be attached, such as key rings, clips, carabiners, trinkets, straps, or the like. The attachment body 1810 may be configured to facilitate attachment of various external devices to the case 1800. The cap 1806 that encloses the electronic tracking device 1802 may be inserted into the opening 1818 in the attachment body 1810 to couple the cap 1806 to the attachment body 1810 by, for example, press fitting.

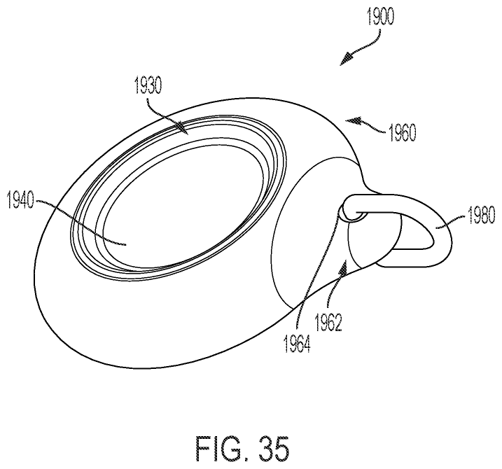

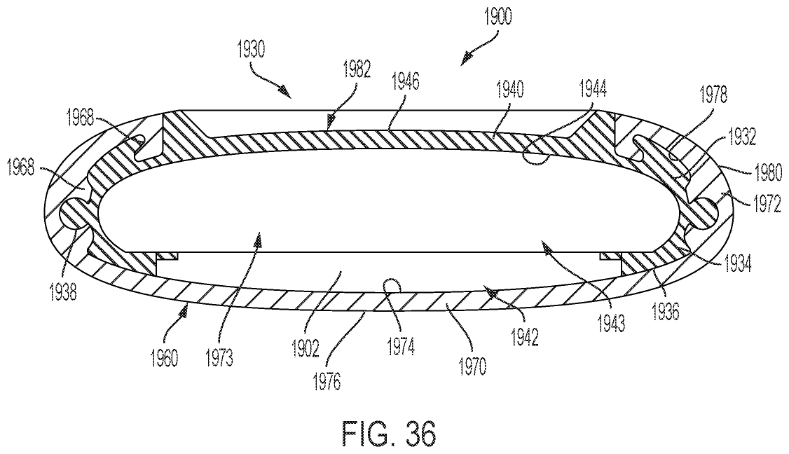

Referring now to FIGS. 35 and 36, another embodiment of a case 1900 is generally depicted. The case 1900 may be substantially similar to the case 1700 described above, and like structure will not be described again for brevity. As such, like features will use the same reference numerals with a prefix “19” for the reference numbers.

The case 1900 may differ from the case 1700 described above in that the case 1900 includes an inner sleeve 1930 that acts as the cap 1706 described above, an outer sleeve 1960, and an attachment device 1980. The electronic tracking device 1902 may be insertable into the inner sleeve 1930. The inner sleeve 1930 is insertable within the outer sleeve 1960 which may create a seal between the inner sleeve 1930 and the outer sleeve 1960. The outer sleeve 1960 may be coupled with the attachment device 1980. In embodiments, the case 1900 may provide protection against kinetic shock, foreign material (e.g., fluid, dust, etc.), loss, or the like. Moreover, the case 1900 may allow for connection of the electronic tracking device 1902 to articles.

According to embodiments, the inner sleeve 1930 includes an end wall 1940, and an annular wall 1932 defining an opening 1942. The end wall 1940 may include an inner surface 1944 and an external surface 1946. The end wall 1940 may be generally circular, elliptical, an n-sided polygonal shape (where n is a number), or irregular in shape. The annular wall 1932 generally circumscribes the wall 1940 and includes an inner surface 1934 and an outer surface 1936. The inner surface 1934 generally abuts the electronic tracking device 1902 when assembled. The annular wall 1932 may define the opening 1942 for receiving the electronic tracking device 1902. The wall 1940 and annular wall 1932 may define a cavity 1943. As described herein, the electronic tracking device 1902 may be inserted within the opening 1942 to be disposed within the cavity 1943. The outer surface 1936 of annular wall 1932 may include scaling formations 1938 that, together with outer sealing formations 1968 of the outer sleeve 1960 form a seal when assembled, as described in more detail herein.

In embodiments, the inner sleeve 1930 may include a plastic, such as high tensile strength silicone material. The silicone material may be transparent, opaque, or non-opaque. According to at least some embodiments, the silicone material is transparent such that indicia on the electronic tracking device 1902 may be visible. It is further noted that the inner sleeve 1930 may be formed of disparate parts that can be attached together. The end wall 1940 may be formed of an acoustic membrane that allows audible signals (e.g., sound) to travel from the electronic tracking device 1902 to an ambient environment.

The outer sleeve 1960 may include a wall 1970, and an annular wall 1972 defining a cavity 1973. The wall 1970 may include an inner surface 1974 and an external surface 1976. The wall 1970 may be generally circular, elliptical, an n-sided polygonal shape (where n is a number), or irregular in shape. The annular wall 1972 generally circumscribes the wall 1970. The annular wall 1972 may include an inner surface 1978. The inner surface 1978 generally abuts the inner sleeve 1930 when assembled. The annular wall 1972 may define an opening 1982. The wall 1970 and annular wall 1972 may define a cavity 1973. As described herein, the electronic tracking device 1902 and the inner sleeve 1930 may be inserted within the opening 1982 and may be disposed within the cavity 1973. In some embodiments, the inner surface 1978 may include outer sealing formations 1968 that, together with the sealing formations 1938 of annular wall 1932 may form a seal when assembled, as described in more detail herein. In other words, the sealing formations 1938 of the inner sleeve 1930 and the outer sealing formations 1968 may couple the outer sleeve 1960 to the inner sleeve 1930 to seal the opening 1942 of the inner sleeve 1930.

The outer sleeve 1960 may include an attachment body 1962 that provides a mechanism for coupling the attachment device 1980 to the attachment inner sleeve 1930. In an embodiment, the attachment body 1962 may include a portion of material having one or more apertures 1964 formed within the portion. The attachment device 1980 may be disposed within or through the one or more apertures 1964. It is noted that the attachment body 1962 may include other appropriate mechanisms, such as magnetic connections, threaded members, channel locking mechanisms, or the like. In embodiments, the outer sleeve 1960 may include a plastic, such as high tensile strength silicone material. The silicone material may be transparent, opaque, or non-opaque. It is further noted that the outer sleeve 1960 may be formed of disparate parts that can be attached together.

The electronic tracking device 1902 may be inserted into the inner sleeve 1930 such that the opening 1942 may be stretched or expanded to allow the electronic tracking device 1902 to pass therethrough. The opening 1942 may be stretched or expanded to allow the electronic tracking device 1902 to pass therethrough. The opening 1942 may revert to a resting or compressing position once the electronic tracking device 1902 is disposed within the cavity 1943. In the compressing position, the inner sleeve 1930 may provide a compressive force to at least some of the electronic tracking device 1902, such that a seal is formed between the inner sleeve 1930 and the electronic tracking device 1902. The seal may be generally fluid proof, dust proof. or the like.

As shown in FIG. 36, the assembled inner sleeve 1930 and electronic tracking device 1902 can be positioned within the outer sleeve 1960, such as passed through the opening 1982 to be disposed within the cavity 1973. When assembled, the wall 1940 may be exposed to an ambient environment while other portions of the inner sleeve 1930 are disposed within the outer sleeve 1960.

The inner sleeve 1930 includes sealing formations 1938 that mate with outer sealing formations 1968 of the outer sleeve 1960 to form a seal when assembled. The sealing formations 1938 and the outer sealing formations 1968 may include one or more slots and protrusions that correspond with each other such that the inner sleeve 1930 and outer sleeve 1960 may be coupled together. The sealing formations 1938 and the outer sealing formations 1968 may each include one or more male tuned slots and/or one or more female tuned slots. It is further noted that the sealing formations 1938 and the outer sealing formations 1968 may be of any appropriate configuration and type, including, without limitation being a threaded portion. magnetic locks, channel locks, a bayonet engaging member, or other formations that can mate with each other. Moreover, the sealing formations 1938 and the outer sealing formations 1968 may be of any appropriate shape, such as hook shaped, jig-saw shaped, or the like.

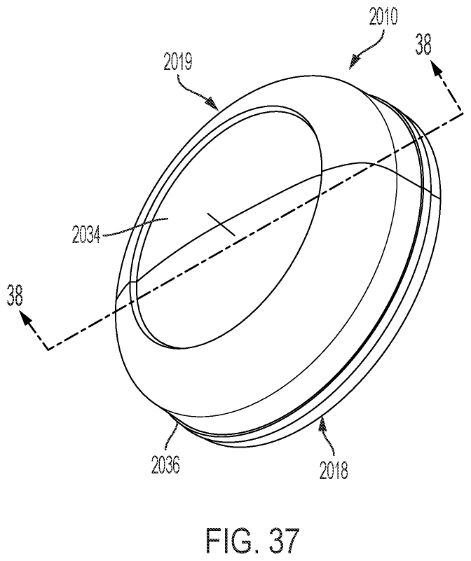

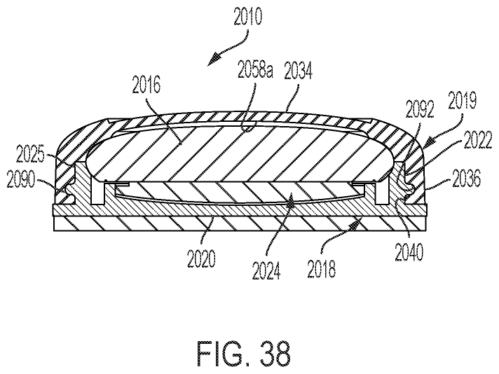

Referring now to FIGS. 37-39, an alternative case 2010 is depicted including a snap fit coupling mechanism for retaining the electronic tracking device in the case. Referring initially to FIGS. 37 and 38, the case 2010 may include a cap 2019 and a base 2018. The base 2018 may include a rear wall 2020 and one or more sidewalls 2022 that extend transversely from the rear wall 2020 to define a base cavity 2024 within which the electronic tracking device 2016 may be received. The sidewall 2022 may include an outer radial surface 2025 that has at least one protrusion 2090 that extends around the sidewall 2022 from the outer radial surface 2025 away from the base cavity 2024. In some embodiments, the outer radial surface 2025 of the one or more sidewalls 2022 may be a single continuous protrusion that circumferentially surrounds the one or more sidewalls 2022.

The cap 2019 of the case 2010 may include an upper member 2034 and one or more sidewalls 2036 that extend transversely from an inner surface 2058a of the upper member 2034 toward the base 2018. The sidewalls 2036 may include an inner radial surface 2040 that defines an annular groove 2092. The annular groove 2092 may circumferential surround at least a portion of the inner radial surface 2040 of the one or more sidewalls 2036. In the secured positon, the protrusion 2090 of the base 2018 engages and is received in the annular groove 2092 to coupled the cap 2019 to the base 2018. Each of the cap 2019 and/or the base 2018 may be formed of a deformable material to allow the base 2018 to pass into the cap 2019 so that the cap 2019 is in a snap fit arrangement with the base 2018 to secure the electronic tracking device 2016 within the base cavity 2024.

While the illustrated case 2010 depicts the sidewalls 2036 of the cap 2019 positioned in the base 2018 when the cap 2019 is coupled to the base 2018, it is contemplated and possible that the sidewalls 2022 of the base 2018 are positioned in the cap 2019 when coupled to the cap 2019.

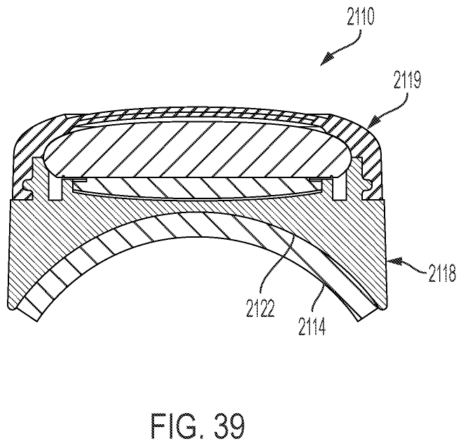

In further alternative embodiments and with reference to FIGS. 39, an alternative case 2110 is depicted. The case 2110 may be substantially similar to the case 2010 described above, and like structure will not be described again for brevity. As such, like features will use the same reference numerals with a prefix “21” for the reference numbers.

The case 2110 may include a cap 2119 and a base 2118 that is structured to be attached, connected, or otherwise adhered to an external curved service (e.g., associated with an item having a location that a user desires to maintain knowledge of). The outer surface 2122 of the base 2118 may be noncoplanar so that the outer surface 2122 may be contoured to a surface of an external object. The outer surface 2122 may be, for example, curved so that the outer surface 2122 may be contoured to a cylindrical surface. However, it is contemplated and possible that the outer surface 2122 may include any other noncoplanar shape for coupling to a surface of an external object, such as a pyramidal shape.

The attachment member 2114 may be shaped to be complementary to the shape of the outer surface so that the attachment member may facilitate attachment between the base and the external object. For example, in embodiments where the outer surface is curved, the attachment member may be similarly curved.

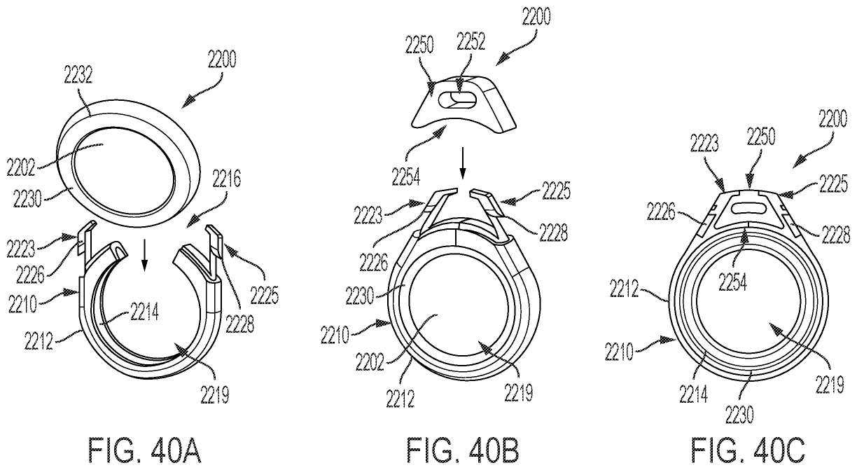

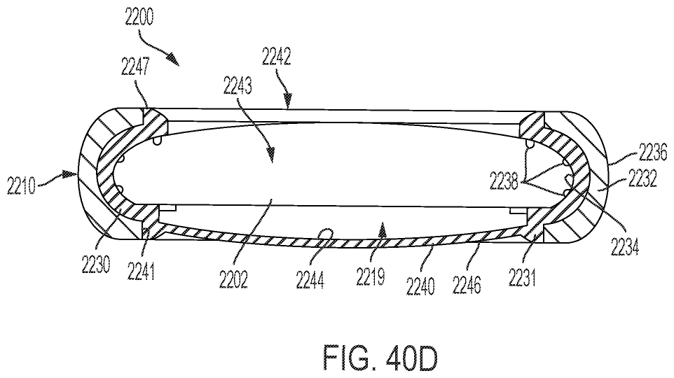

Referring now to FIGS. 40A-40D, an embodiment of a case 2200 for an electronic tracking device 2202 is generally depicted. The case 2200 generally includes a body 2210, a sleeve 2230, and a locking mechanism 2250. The electronic tracking device 2202 may be insertable into the sleeve 2230 and the sleeve 2230 may be insertable into the body 2210 to couple the electronic tracking device 2202 to the body 2210. The locking mechanism 2250 may lock the body 2210 with the sleeve 2230 and the electronic tracking device 2202 disposed therein. In embodiments, the case 2200 may provide protection against kinetic shock, foreign material (e.g., fluid, dust, etc.), loss, or the like. Moreover, the case 2200 may allow for connection of the electronic tracking device 2202 to articles.

The sleeve 2230 may include a rear wall 2240 and an annular wall 2232. The wall 2240 may include an inner surface 2244 and an external surface 2246. The wall 2240 may be generally circular, elliptical, an n-sided polygonal shape (where n is a number), or irregular in shape. The annular wall 2232 generally circumscribes the wall 2240. The annular wall 2232 includes an inner surface 2234 and an outer surface 2236. The annular wall 2232 may define an opening 2242. The wall 2240 and annular wall 2232 may define a cavity 2243. As described herein, the electronic tracking device 2202 may be inserted within the opening 2242 and may be disposed within the cavity 2243. In embodiments, the sleeve 2230 may include a plastic, such as high tensile strength silicone material. The silicone material may be transparent, opaque, or non-opaque. According to at least some embodiments, the silicone material is transparent such that indicia may be visible on the electronic tracking device 2202. It is further noted that the sleeve 2230 may be formed of disparate parts that can be attached together.

In embodiments, the sleeve 2230 may include an alignment protrusion 2231 that extends from the rear wall 2240 to align the sleeve 2230 with the body 2210 when assembled. The alignment protrusion 2231 may be positioned adjacent the annular wall 2232. For instance, the alignment protrusion 2231 may include an annular lip or ledge extending from either side of the annular wall 2232. The alignment protrusion 2231 may abut against inner ledges 2241 and 2247 of the body 2210. The alignment protrusion 2231 and the inner ledges 2241 and 2247 may be shaped and sized to cooperatively engage with each other such that the sleeve 2230 may be aligned with the body 2210 when assembled.

Referring to FIG. 40D, the sleeve 2230 can include sealing mechanisms 2238 projected or formed at or on the inner surface 2234 of the sleeve 2230. The sealing mechanisms 2238 may include a plurality of protrusions extending from the inner surface 2234 towards an electronic tracking device 2202, when assembled. The sealing mechanisms 2238 may be compressed against the electronic tracking device 2202 such that a foreign material is prevented or reduced from passing around the electronic tracking device 2202 and towards the wall 2240. It is noted that the sealing mechanisms 2238 may include a plurality or annular or ring shaped projections that may provide for a plurality of seals formed between the electronic tracking device 2202 and the sleeve 2230.

The body 2210 may include an internal surface 2214, an external surface 2212, a first prong 2223, and a second prong 2225. The internal surface 2214 and an external surface 2212 may be generally rounded, and define both an opening 2216 and a cavity 2219 for receiving the electronic tracking device 2202. The opening 2216 may extend through the external surface 2212 to the cavity 2219 to allow the electronic tracking device and sleeve 2230 to be inserted through the opening 2216 into the cavity 2219.

In some examples, the external surface 2212 may be smooth, matte finished, include ribs to aid in gripping, or the like It is noted that the body 2210 may be formed in other shapes, such as generally elliptical, an n-sided polygonal shape (where n is a number), or irregular in shape. Moreover, the body 2210 may include an appropriate shape and size for a particular electronic tracking device 2202, such as an APPLE AIRTAG.

The first prong 2223 may include a first tab 2226, and the second prong 2225 may include a second tab 2228. The tabs 2226. 2228 may be configured to engage the locking mechanism 2250 for retaining the locking mechanism 2250 to the body 2210.

The body 2210 may include a plastic, metal, or natural material. In at least one embodiment, the body 2210 includes a polycarbonate, or a high tensile strength silicone material. It is further noted that the body 2210 may be formed of disparate parts that can be attached together.

In embodiments, the body 2210 may include a hinge, such as a living hinge, where the body 2210 may be deformed to move the first prong 2223 away from the second prong 2225 to allow access through the opening 2216. The hinge may allow the body 2210 to flex or deform. and then revert back to a resting shape. For instance, and as best shown in FIG. 40A, the body 2210 may be flexed such that the opening 2216 is widened to allow the assembled sleeve 2230 and electronic tracking device 2202 to be disposed within the body 2210. As shown in FIG. 40B. the body 2210 may then be allowed to revert to a resting state, where the body 2210 may include a compressive force to the assembled sleeve 2230 and electronic tracking device 2202, thereby restricting access through the opening 2216.

The body 2210 may be locked into position, via a clip, threaded member, latch, magnetic lock, a keyed lock, a hoop, or the like. The locking mechanism 2250 can be attached to the first prong 2223 and the second prong 2225 such that the first prong 2223 and the second prong 2225 pass through an opening 2254 defined by the locking mechanism 2250. The first tab 2226 of the first prong 2223 and the second tab 2228 of the second prong 2225 may then contact the locking mechanism 2250 to secure the locking mechanism 2250 to the body 2210, as shown in FIG. 40C. The case 2200, when assembled, may provide a waterproof housing for appropriate portions of the electronic tracking device 2202 positioned therein.

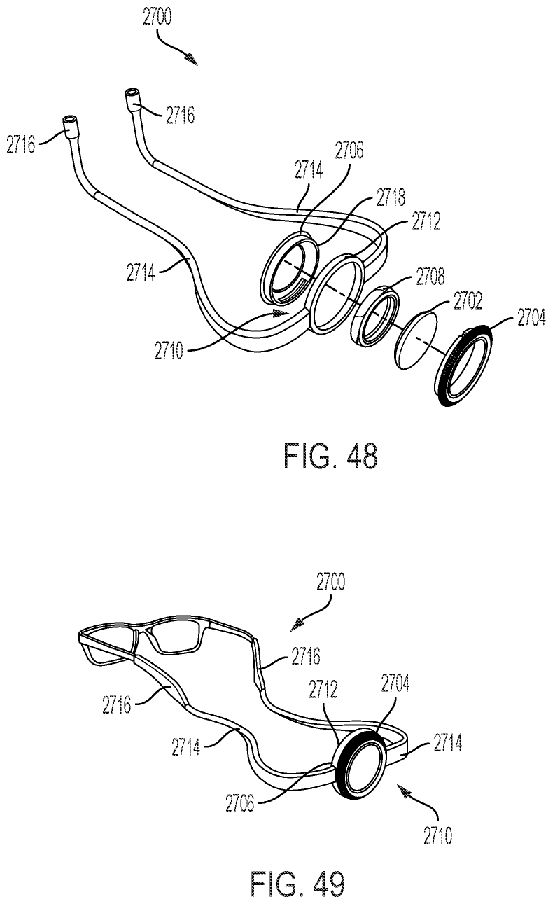

The locking mechanism 2250 may further define an aperture 2252 configured to receive a clip, carabiner, cord, or other appropriate component such that the locking mechanism 2250 may be secured to an article. Moreover, the locking mechanism 2250 may include a plastic. metal, or natural material. It is further noted that the locking mechanism 2250 may be formed of disparate parts that can be attached together. In some embodiments, the body 2210 may include an extension, such as a hoop or the like that lockably couples to the body 2210 and can be unlocked and/or partially disconnected from the body 2210 such that accessories, such as keys, key fobs. remotes, and/or the like can be threaded onto the extension and then secured when the extension is reconnected and/or locked to the body 2210 (see, e.g., discussion with respect to FIGS. 48-49).

As shown in FIG. 40B, the opening 2242 may revert to a resting or compressing position once the electronic tracking device 2202 is disposed within the cavity 2243. In the compressing position, the sleeve 2230 may provide a compressive force to at least some of the electronic tracking device 2202, such that a seal is formed between the sleeve 2230 and the electronic tracking device 2202. The seal may be generally fluid proof, dust proof, or the like.

Moreover, the opening 2242 in the sleeve 2230 may allow audible output from the electronic tracking device 2202 to be unobstructed. For example, a user may attach the case 2200 including the electronic tracking device 2202 to an article. The user may access a computing device, such as a cellular phone, wearable device (e.g., smart watch), tablet computer, laptop computer, desktop computer, or the like. The user can trigger an alarm that causes the electronic tracking device 2202 to generate sounds. As the opening 2242 does not interfere with the audible output, the user may be able to locate the article and/or the electronic tracking device 2202. According to embodiments, the assembled sleeve 2230 and electronic tracking device 2202 may be positioned within the body 2210, as shown in FIG. 40C.

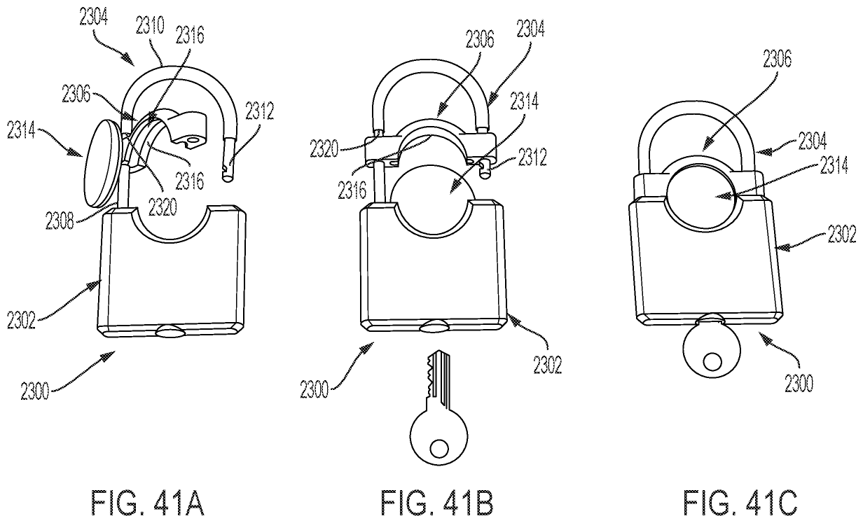

Additional embodiments of a case may incorporate features of a locking mechanism, such as a combination lock for example. Initially referring to FIGS. 41A-41C, a lock 2300 capable of retaining an electronic tracking device 2314 is depicted. The lock 2300 may include a base 2302, a locking arm 2304, and a retaining member 2306. The locking arm 2304 may include an elongated portion 2308 extending from inside of the base 2302 and away from the base 2302, a curved portion 2310 that extends from the elongated portion 2308 toward the base 2302, and a locking portion 2312 configured to selectively engage the base 2302. The curved portion 2310 may include a thickness that is greater than a thickness of the elongated portion 2308 so that the curved portion 2310 defines an engaging surface 2320 that engages the retaining member 2306 to move the retaining member 2306 with the locking arm 2304.

The retaining member 2306 may be slidably coupled to the locking arm 2304 and be shaped to receive the electronic tracking device 2314 and enclose the electronic tracking device 2314 between the retaining member 2306 and the base 2302. The movement of the retaining member 2306 may be restricted by the engaging surface 2320 on the curved portion 2310, such that the retaining member 2306 may only slide about the elongated portion 2308 of the locking arm 2304. The retaining member 2306 may include a channel 2316 formed therein that is shaped to be complementary to the shape of the electronic tracking device, so that the electronic tracking device may be partially positioned in the channel 2316.

The lock 2300 may function as a traditional lock, such as a lock for a gym locker. Specifically, the locking arm 2304 may move between an engaged position (FIG. 41C) and a disengaged position (FIGS. 41A-41B). Referring to FIG. 41C, in the engaged position, the base 2302 may engage the locking portion 2312 (FIG. 41A) of the locking arm 2304 to retain the locking arm 2304 in the engaged position. Referring to FIG. 41A, in the disengaged position, the locking portion 2312 of the locking arm 2304 is spaced apart from the base 2302. In the disengaged position, the locking arm 2304 is operable to receive a portion of an item that the lock 2300 can be coupled to. The base 2302 is configured to receive a key that, when inserted into the base 2302 and turned, may move the locking arm 2304 from the engaged position to the disengaged position.

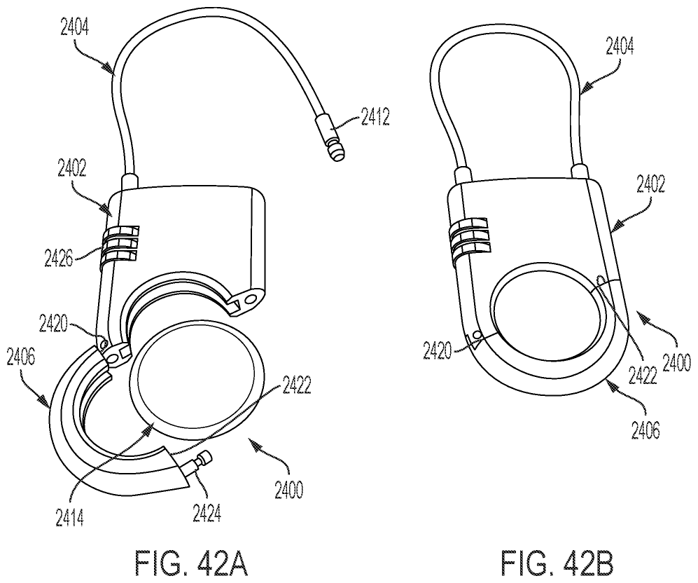

Referring to FIGS. 42A-42B, another embodiment of a lock 2400 capable of retaining an electronic tracking device 2414 is depicted. The lock 2400 may include a base 2402, a locking arm 2404, and a retaining member 2406. The locking arm 2404 may be a flexible cable that extends from the base 2402, and include a locking portion 2412 configured to selectively engage the base 2402. The locking portion 2412 may be inserted into the base 2402 when the lock 2400 is locked, where the locking portion 2412 is retained by the base 2402 to prevent movement of the locking portion 2412.

The retaining member 2406 may include a first end 2420 rotatably coupled to the base 2402 and an opposite second end 2422 to which a locking feature 2424 is attached. The locking feature 2424 may be insertable into the base 2402, such that when the lock 2400 is locked, the locking feature 2424 is retained by the base 2402 to prevent movement of the retaining member 2406. The retaining member 2406 may be shaped to receive the electronic tracking device 2414 and enclose the electronic tracking device 2414 between the retaining member 2406 and the base 2402 so that when the locking feature 2424 is retained by the base 2402, the electronic tracking device 2414 may not be removed from the lock 2400.

The lock 2400 may function as a traditional lock, such as a lock for a gym locker. Specifically, the locking arm 2404 may move between an engaged position (FIG. 42B) and a disengaged position (FIG. 42A). Referring to FIG. 42A, in the disengaged position, the locking portion 2412 of the locking arm 2404 is spaced apart from the base 2402. In the disengaged position, the locking arm 2404 is operable to receive a portion of an item that the lock 2400 can be coupled to. The base 2402 includes a combination lock that moves the locking arm 2404 from the engaged position to the disengaged position when a predetermined combination is entered into the combination lock. Further in the disengaged position, the locking feature 2424 of the retaining member 2406 is spaced apart from the base 2402 so that the retaining member 2406 may pivot relative to the base 2402 and receive the electronic tracking device 2414.

Referring to FIG. 42B, in the engaged position, the base 2402 may engage the locking portion 2412 (FIG. 42A) of the locking arm 2404 to retain the locking arm 2404. The base 2402 may similarly engage the locking feature 2424 of the retaining member 2406 to retain the retaining member 2406 and prevent the electronic tracking device 2414 from moving.

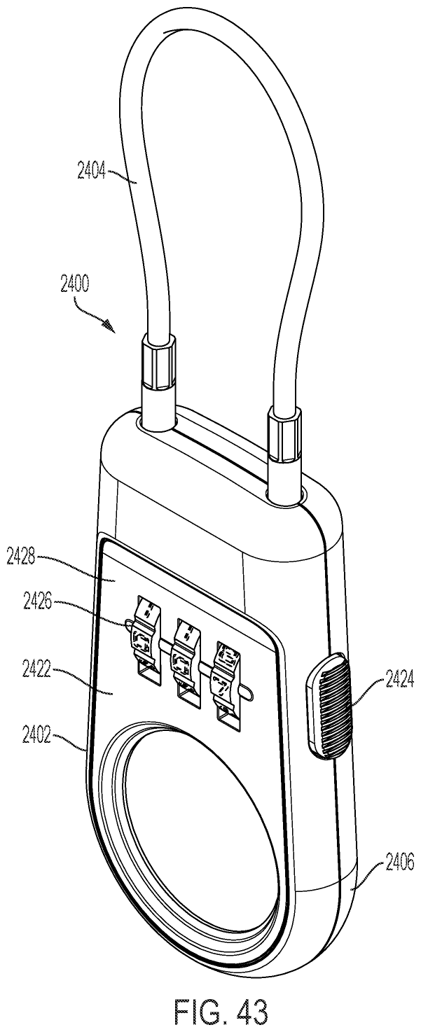

The combination lock may include a series of dials 2426, such as in a traditional combination lock. The series of dials 2426 may be positioned on a side of the base 2402, such as depicted in FIGS. 42A-42B. However, it is contemplated and possible that the series of dials 2426 may be positioned anywhere on the lock 2400. For example and briefly referring to FIG. 43, the dials 2426 may be positioned on a face 2428 of the base 2402 of the lock 2400.

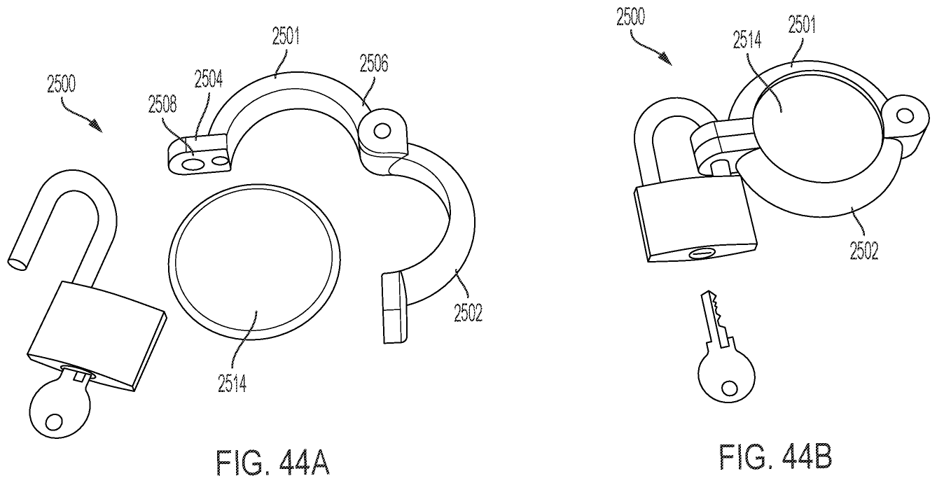

Referring to FIGS. 44A-44B, a case 2500 capable of retaining an electronic tracking device 2514 is depicted. The case 2500 may include a base 2501 and a retaining member 2502 rotatably coupled to one another at a first end 2506. The base 2501 and the retaining member 2502 include lock-receiving bores 2508 extending through each of the base 2501 and retaining member 2502 at a second end 2504 opposite the first end 2506. The base 2501 and retaining member 2502 are operable to receive the electronic tracking device 2514. The base 2501 and retaining member 2502 may move between an open position (FIG. 44A) and a closed position (FIG. 44B). Referring to FIG. 44A, in the open position, the second end 2504 of each of the base 2501 and retaining member 2502 are pivoted away from each other to receive the electronic tracking device 2514. Referring to FIG. 44B, in the closed position, the second end 2504 of cach of the base 2501 and the retaining member 2502 contact the other of the base 2501 and retaining member 2502, such that the lock-receiving bores 2508 of each of the base 2501 and retaining member 2502 are aligned. When the lock-receiving bores 2508 are aligned, the base 2501 and retaining member 2502 are operable to receive a lock that may retain the base 2501 and the retaining member 2502 together.

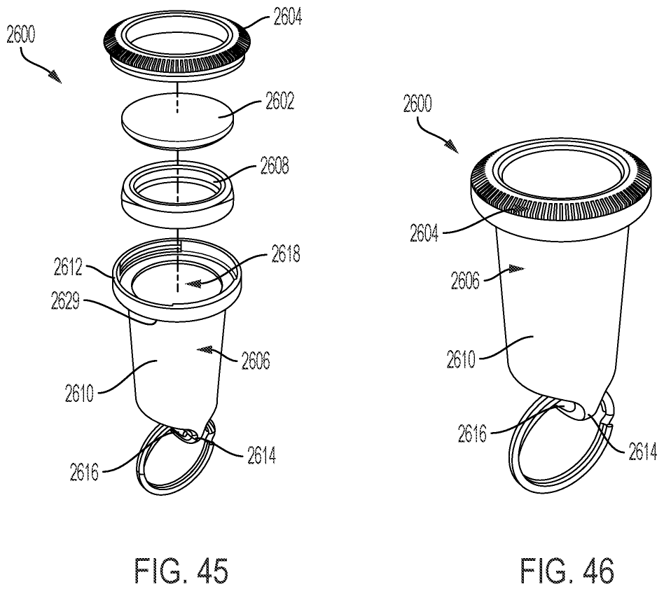

Additional embodiments may include a case configured to be buoyant. Referring initially to FIGS. 45 and 46, a buoyant case 2600 for an electronic tracking device 2602 is depicted. The case 2600 is configured to float when placed in the fluid. The case 2600 may include a cap 2604, a base 2606, and a sleeve 2608. The cap 2604, the base 2606, and the sleeve 2608 may be structurally similar to the cap 419, the base 418, and the covering member 474 of FIG. 6 described above. Accordingly, like structure will not be described again for brevity.

The sleeve 2608 may be a seal or waterproof member described in any of the previous embodiments herein. The cap 2604 may be removably coupled to the base 2606 in any manner as described in the previous embodiments, such as, for example, the cap 2604 may be threadably engaged with the base 2606. The base 2606 may include a hollow protrusion 2610 that extends from an outer surface 2629 of the base 2606, and a sidewall 2612 that circumferentially surrounds the outer surface 2629.

The hollow protrusion 2610 may include a tab 2614 extending from the hollow protrusion 2610, and defines an aperture 2616 extending through the tab 2614. The aperture 2616 may be configured to receive and thereby couple to an external object, such as a keyring. The hollow protrusion 2610 of the base 2606 may define a cavity 2618 therein. The hollow protrusion 2610 and the cavity 2618 may be sized, shaped, and formed of a material to be buoyant so that the case 2600 floats when placed in water. In embodiments, the cavity 2618 may be empty or house a material, for example foam, to facilitate floatation.

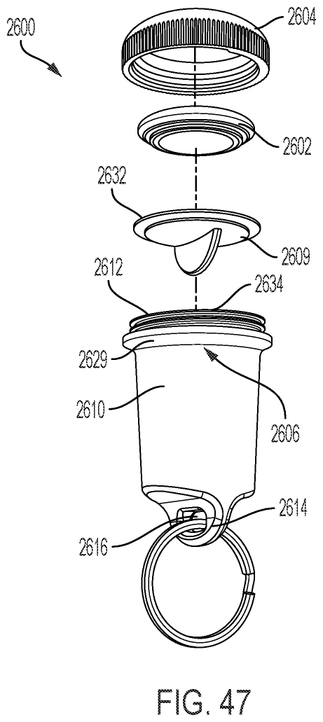

In some embodiments and with reference to FIG. 47, the case 2600 may include an alternative sleeve 2609 that is a disk that is positioned between the electronic tracking device 2602 and the cavity 2618 in the hollow protrusion 2610 of the base 2606 to seal the cavity 2618 and the electronic tracking device 2602 within the case 2600. The sleeve 2609 may include a flange 2632 that is configured to contact a terminating edge 2634 of the base 2606. When the cap 2604 is attached to the base 2606, the flange 2632 is compressed between the cap 2604 and the base 2606 to seal the electronic tracking device 2602 between the cap 2604 and the base 2606.

In further embodiments of a case for an electronic tracking device, the case may include an attachment portion that is positionable between a cap and a base, and retained by the cap and the base when the cap is coupled to the base. The cap and the base may be any of the caps and bases described above, in which the cap is coupled to the base in any described manner, such as a press fit coupling, a threaded screw coupling, or the like. Accordingly, for brevity, in each of the following embodiments, the features regarding the cap, the base, and the coupling mechanism for coupling the cap to the base will only be briefly described for purposes of brevity.

Referring initially to FIGS. 48 and 49, a case 2700 for an electronic tracking device 2702 is depicted. The case 2700 generally includes a cap 2704, a base 2706, and a sleeve 2708 similar to the other embodiments described herein for providing a seal around the electronic tracking device 2702. The case 2700 may further include an attachment assembly 2710 for coupling the case 2700 to an external object such as, for example, a pair of headphones or carpieces on a pair of glasses. The attachment assembly 2710 may include an attachment member 2712, a pair of tethers 2714 extending from the attachment member 2712, and a pair of deformable cups 2716 coupled to each of the tethers 2714. The pair of deformable cups 2716 are configured to deform over the external object, thereby coupling the attachment assembly 2710 to the external object. The attachment member 2712 may extend around a sidewall 2718 extending from the base 2706 of the case 2700, where the attachment member 2712 is sandwiched between the base 2706 and the cap 2704 when the base 2706 and the cap 2704 are coupled together.

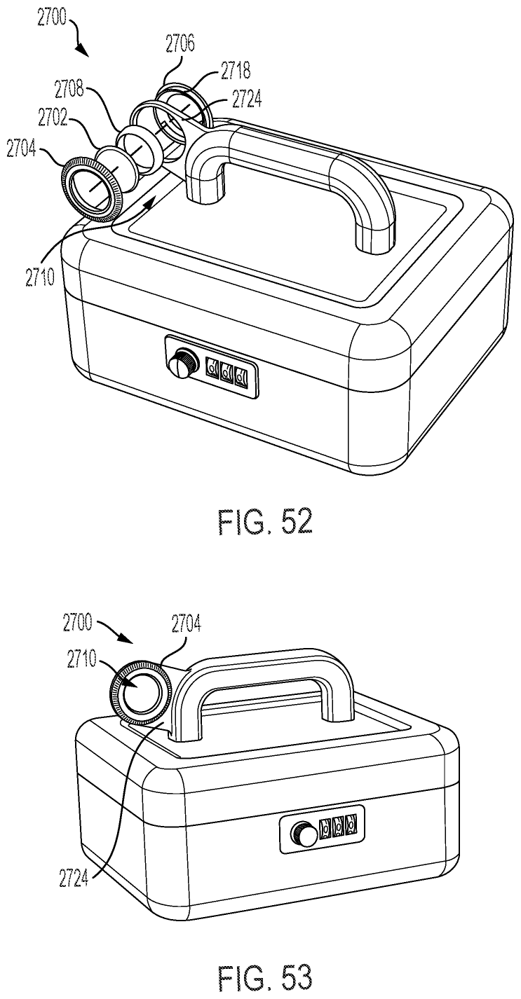

The attachment assembly 2710 may be configured to attach to additional objects, such as, for example, a pillbox, a safe, a container, or the like. In embodiments, the attachment member 2712 of the attachment assembly 2710 may be shaped to couple the other object to the case 2700. In embodiments, the attachment member 2712 may be formed with a portion of the other object. For further example, referring to FIGS. 50 and 51, the attachment assembly 2710 may include an attachment member 2722 that is formed as an extension of a pillbox 2720, such that the case 2700 may be coupled to the pillbox 2720 by coupling to the attachment member 2722. For yet another example, referring to FIGS. 52 and 53, the attachment assembly 2710 may include an attachment member 2724 that is formed as an extension of a handle of a safe or other container, such that the case 2700 may be coupled to the handle. However, it is contemplated that other attachment locations on the safe or other container are also possible.

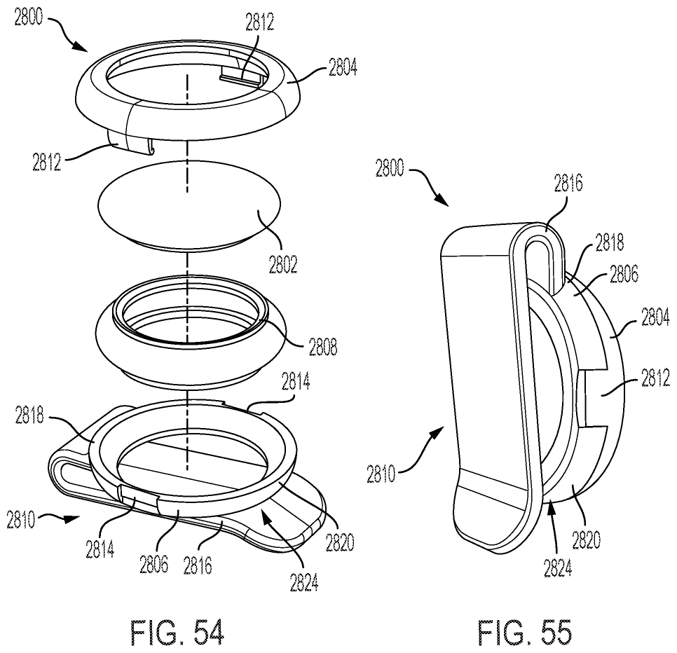

Referring to FIGS. 54 and 55, a case 2800 for an electronic tracking device 2802 is depicted. The case 2800 generally includes a cap 2804, a base 2806, and a sleeve 2808 similar to the other embodiments described herein. As such, the case 2800 may include any of the features disclosed above. For example, the cap 2804 may include a pair of tabs 2812 that are configured to engage a pair of depressions 2814 formed within the base 2806, such that the cap 2804 may be coupled to the base 2806 via press fitting. The case 2800 may further include an attachment assembly 2810 for attaching the case 2800 to an external object. The attachment assembly 2810 may be a clip, where the attachment assembly 2810 may be attached to the external object by sliding the case 2800 into contact with the external object. The attachment assembly 2810 may include a tab 2816 extending from a first side 2818 of the base 2806 toward a second side 2820 opposite the first side 2818. The tab 2816 may be spaced apart from the second side 2820 of the base 2806 to define a gap 2824 that is configured to receive an object. The tab 2816 may be configured to deform when an external object is positioned in the gap 2824 between the tab 2816 and the base 2806. The deformation of the tab 2816 biases the tab 2816 toward the base 2806. applying a compressive force to the external object, and, thereby coupling the case 2800 to the external object.

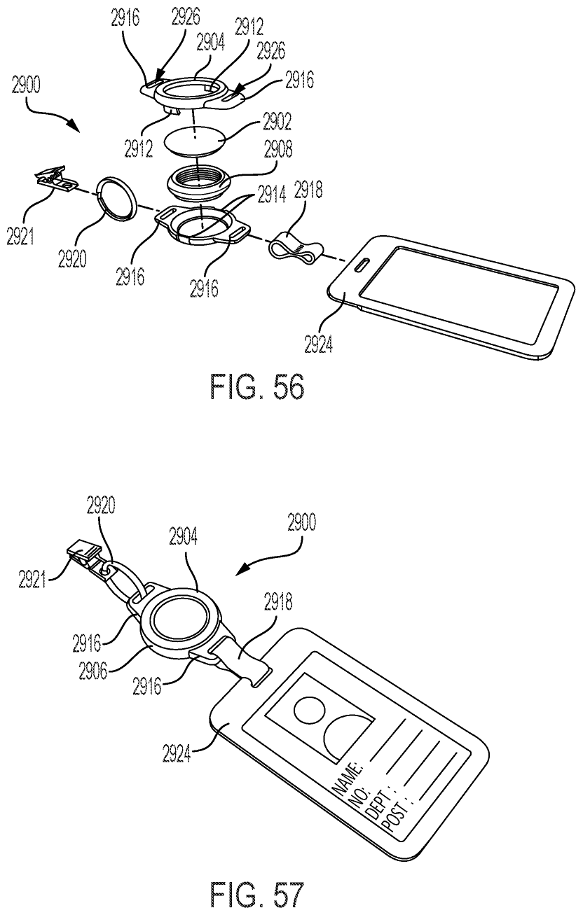

Referring to FIGS. 56 and 57, in some embodiments, the case 2800 may be used in conjunction with an identification badge 2924. Particularly, a case 2900 may generally include a cap 2904, a base 2906, and a sleeve 2908 similar to the case 2800 described above to house an electronic tracking device 2902. As such, the case 2900 may include any of the features disclosed above. For example, the cap 2904 may include a pair of tabs 2912 that are configured to engage a pair of depressions 2914 formed within the base 2906, such that the cap 2904 may be coupled to the base 2906 via press fitting. The cap 2904 and/or the base 2906 may include attachment portions 2916 extending from opposing sides of the respective cap 2904 and/or base 2906. The case 2900 may be configured to be coupled to an external object, such as an identification badge 2924. In embodiments, external object, such as the ID badge, may include a first connector 2918 and a second connector 2920. The first connector 2918 may be configured to couple to the identification badge 2924, and the second connector 2920 may include a clip 2921 that is configured to couple to an additional external object, such as clothing. The first connector 2918 and the second connector 2920 may be coupled to the attachment portions 2916 of the cap 2904 and/or the base 2906. Particularly, the attachment portions 2916 may define an aperture 2926 formed therein that the first connector 2918 and the second connector 2920 are configured to be positioned therein to couple the first connector 2918 and the second connector 2920 thereto.

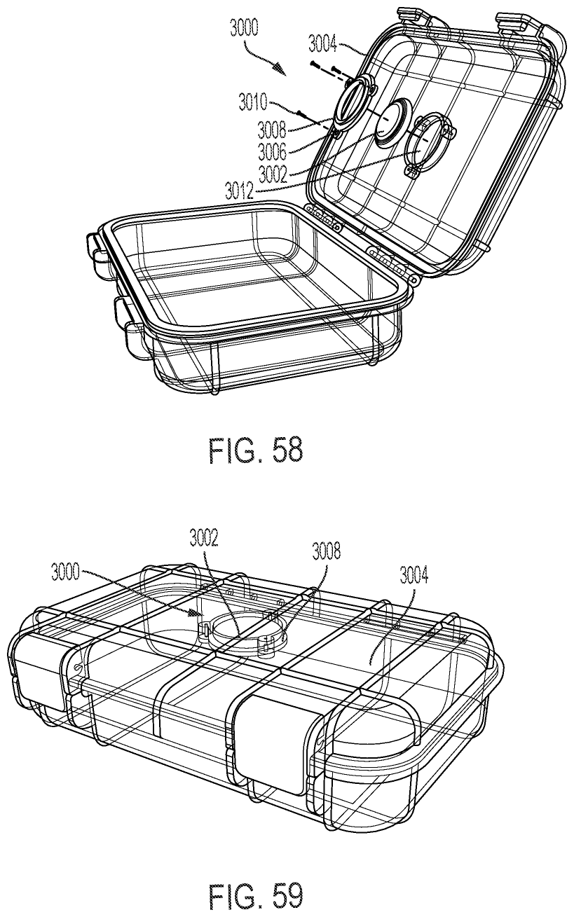

Referring to FIGS. 58 and 59, an attachment assembly 3000 for coupling an electronic tracking device 3002 to a container 3004 (e.g., a dry box or the like) is depicted. The attachment assembly 3000 includes a plurality of tabs 3006 extending from a main body 3008. The attachment assembly 3000 may be coupled to the container 3004 via fasteners 3010 extending through the tabs 3006 of the attachment assembly 3000 and into the container 3004. The main body 3008 is configured to engage the electronic tracking device 3002 and, when coupled to the container 3004, maintain the electronic tracking device 3002 between the attachment assembly 3000 and the container 3004. The container 3004 may include a depression 3012 formed therein for receiving at least a portion of the electronic tracking device 3002.

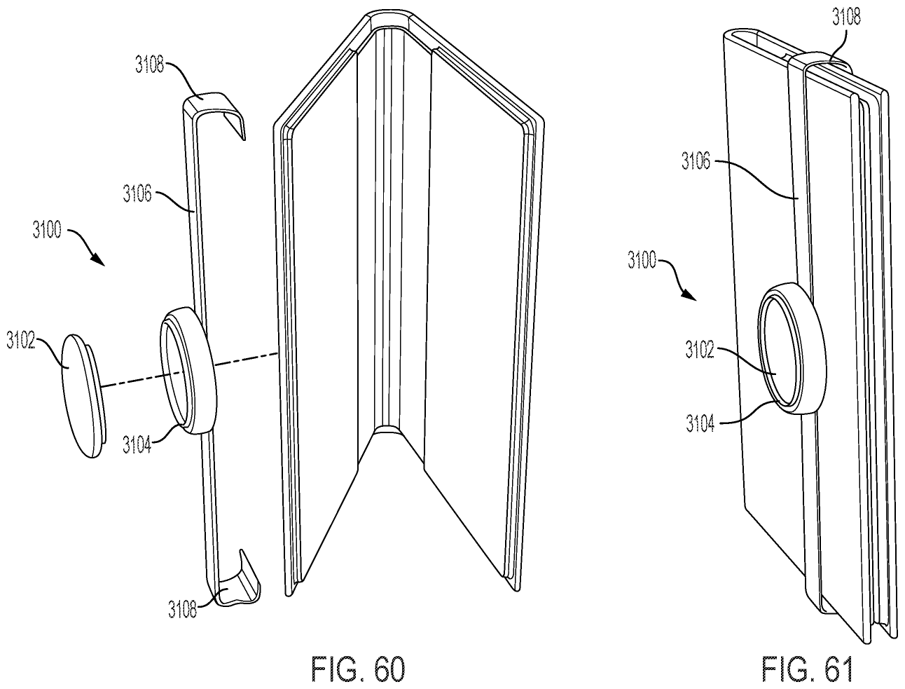

Referring to FIGS. 60 and 61, a case 3100 for an electronic tracking device 3102 is depicted. The case 3100 may be configured to couple to an external object, such as a passport. a book, or the like. The case 3100 may include a sleeve 3104, and a pair of straps 3106 extending from opposing sides of the sleeve 3104. The sleeve 3104 may be similar to previous embodiments. such that the sleeve 3104 forms a seal around the electronic tracking device 3102. The straps 3106 may each include a claw 3108 configured to wrap around and engage a portion of the external object (e.g., a book, a wallet or the like).

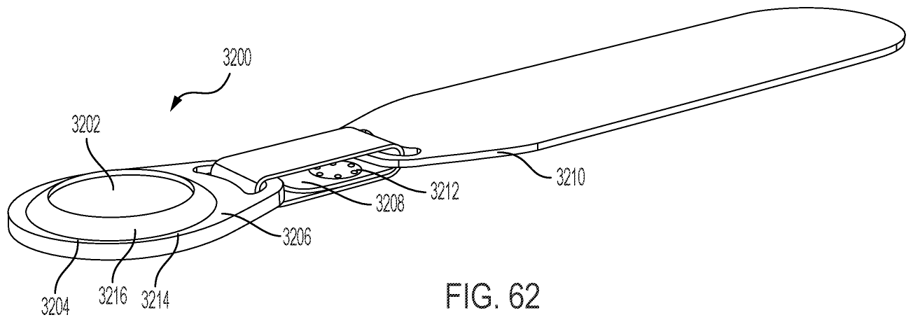

Referring to FIG. 62, a case 3200 for an electronic tracking device 3202 is depicted. The case 3200 may generally include a cap 3204 with an attachment portion 3206. The electronic tracking device 3202 may be coupled to the cap 3204 similar to the other embodiments described herein. As such, the case 3200 may include any of the features disclosed above. The cap 3204 may include an attachment portion 3206 that is configured to be coupled to a marker 3210 via a connector 3208. The attachment portion 3206 may extend from a periphery 3214 of a main body 3216 of the cap 3204, where the main body 3216 houses the electronic tracking device 3202. The marker 3210 may be configured to operate as a bookmark. The connector 3208 may be a band including ends that are coupled together via a fastener 3212 to form a loop. While the connector 3208 is depicted as a loop, the connector 3208 may have any size and shape to couple the marker 3210 to the case 3200. For example, the case 3200 may include the connector 3208 that is coupled to the attachment portion 3206 of the case 3200 and the marker 3210. In embodiments, the connector 3208 may be a cord that is tied to each of the attachment portion 3206 and the marker 3210.

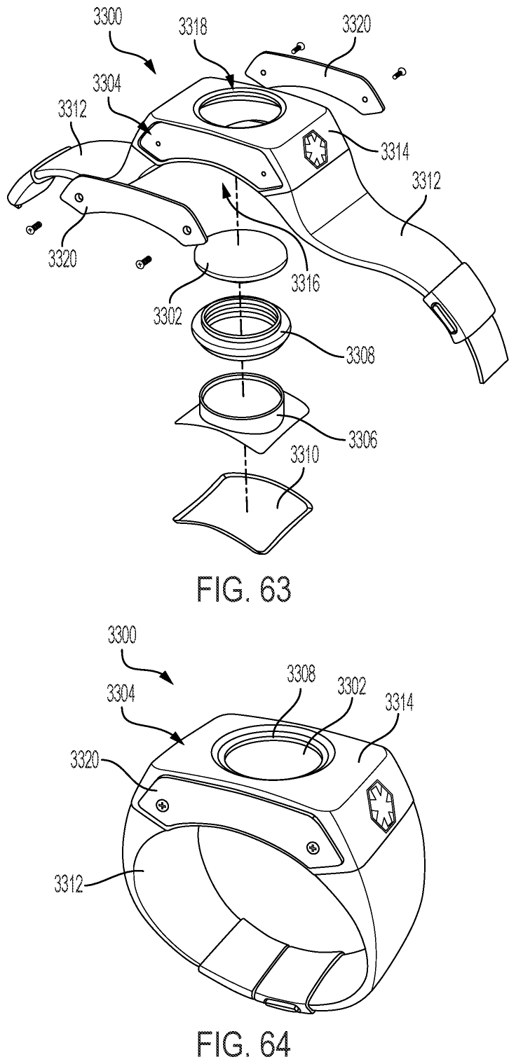

Referring to FIGS. 63 and 64, a wearable case 3300 for an electronic tracking device 3302 is depicted. The wearable case 3300 may include a housing 3304, an insert 3306, a sleeve 3308, and a back-plate 3310. The sleeve 3308 may be similar to the other embodiments described herein. The housing 3304 may include a pair of bands 3312 extending from a main body 3314 of the housing 3304. The bands 3312 may be formed of a flexible material, such as silicon, so that the bands 3312 may extend around an object, such as a wearer's wrist, and be coupled together. The bands 3312 may be coupled together by a buckle, a fastener, or the like. The housing 3304 may include a cavity 3316 formed in the main body 3314, the cavity 3316 being configured to receive the electronic tracking device 3302. The housing 3304 may define an opening 3318 positioned therein to allow the electronic tracking device 3302 to be visible through the housing 3304. The insert 3306 may be inserted into the cavity 3316 to couple the electronic tracking device 3302 between the insert 3306 and the housing 3304. The back-plate 3310 may be coupled to the housing 3304 to maintain the electronic tracking device 3302 and the insert 3306 within the cavity 3316. The back-plate 3310 may be coupled to the housing 3304 via fasteners, adhesive, welding. press-fitting, or the like. The wearable case 3300 may be configured to track a wearer, such as a patient in a hospital. The housing 3304 may further include plates 3320 coupled to the main body 3314. The plates 3320 may include information thereon, such as medical information, contact information, and/or the like. In some embodiments, the housing 3304 may include other electronic components, such as communication components (microphones, speakers, a processing device. one or more radios, and/or the like).

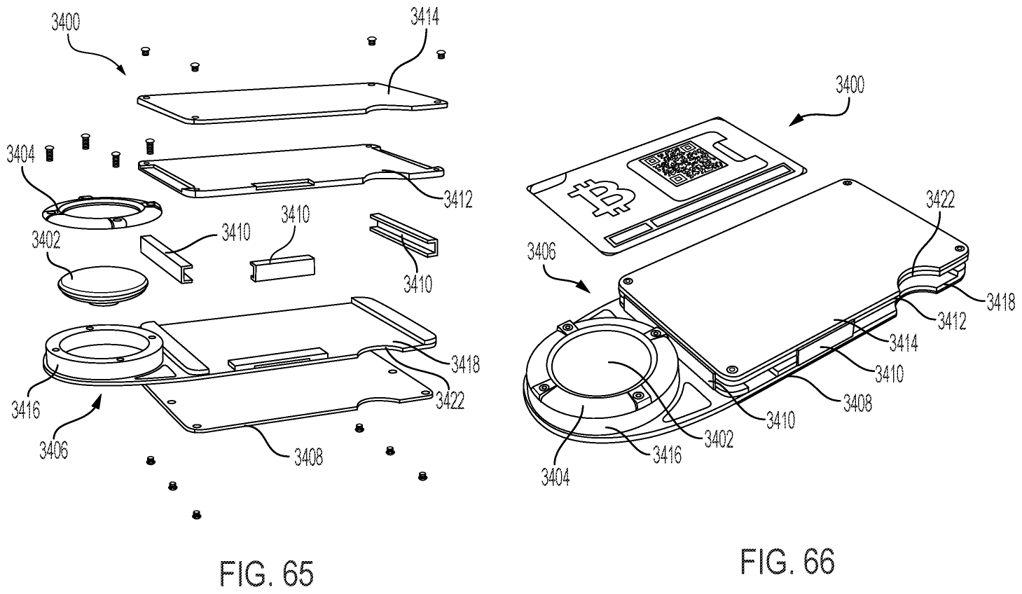

Referring to FIGS. 65 and 66, a case 3400 for an electronic tracking device 3402 is depicted. The case 3400 may be configured to operate as a wallet, specifically, a wallet for a cryptocurrency physical key. The case 3400 may include a cap 3404, a sleeve 3406, a back-plate 3408, a plurality of brackets 3410, a frame 3412, and a top plate 3414. The sleeve 3406 may include a base 3416 for receiving the electronic tracking device 3402, and a platform 3418. The cap 3404 may be coupled to the base 3416 via a plurality of fasteners. In embodiments, the cap 3404 may be coupled to the base 3416 in any manner, such as described in the previous embodiments. The electronic tracking device 3402 may be positioned between the cap 3404 and the base 3416 such that the electronic tracking device 3402 is coupled to the case 3400. The top plate 3414, the frame 3412, the platform 3418 of the sleeve 3406, and the back-plate 3408 may be layered in that order, and coupled together. The brackets 3410 may be coupled between the frame 3412 and the platform 3418 to space the platform 3418 from the frame 3412. The space between the platform 3418 and the frame 3412 may be used to hold cards, such as credit cards or physical cryptocurrency keys. The brackets 3410 may be made of an elastic material, to allow the spacing between the platform 3418 and the frame 3412 to expand and contract. The variable spacing allows a variable amount of cards to be held by the case 3400. Each of the sleeve 3406, the back-plate 3408, the frame 3412, and the top plate 3414 may include a notch 3422 formed therein that the cards extend into when positioned between the platform 3418 and the frame 3412 to allow a user to push the cards out of the wallet.

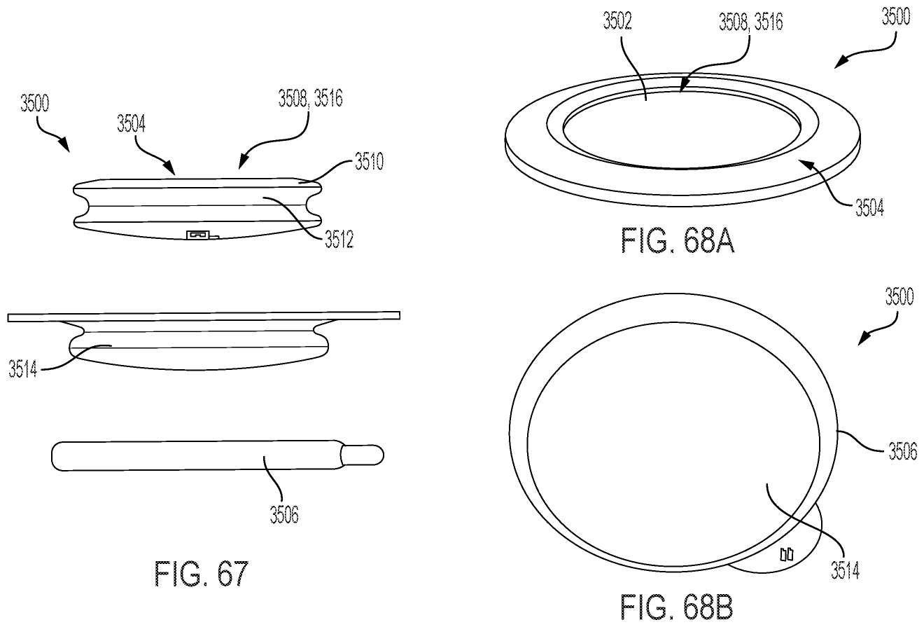

Referring now to FIGS. 67. 68A, and 68B, an attachment assembly 3500 for attaching an electronic tracking device 3502 to a fabric 3514 is depicted. The attachment assembly 3500 may include a sleeve 3504, and a fixing ring 3506. The sleeve 3504 may include an inner cavity 3508 configured to receive and maintain the electronic tracking device 3502, an opening 3516 extending to the inner cavity 3508, a rim 3510, and a groove 3512 formed in the rim 3510. The fixing ring 3506 may be formed of an elastic material to allow the fixing ring 3506 to elastically deform. The electronic tracking device 3502 may be coupled to the fabric 3514 by inserting the electronic tracking device 3502 through the opening (not shown) into the inner cavity 3508 of the sleeve 3504, covering the opening with the fabric 3514, and extending the fixing ring 3506 over the sleeve 3504, and positioning the fixing ring 3506 within the groove 3512 with the fabric 3514 positioned therebetween.

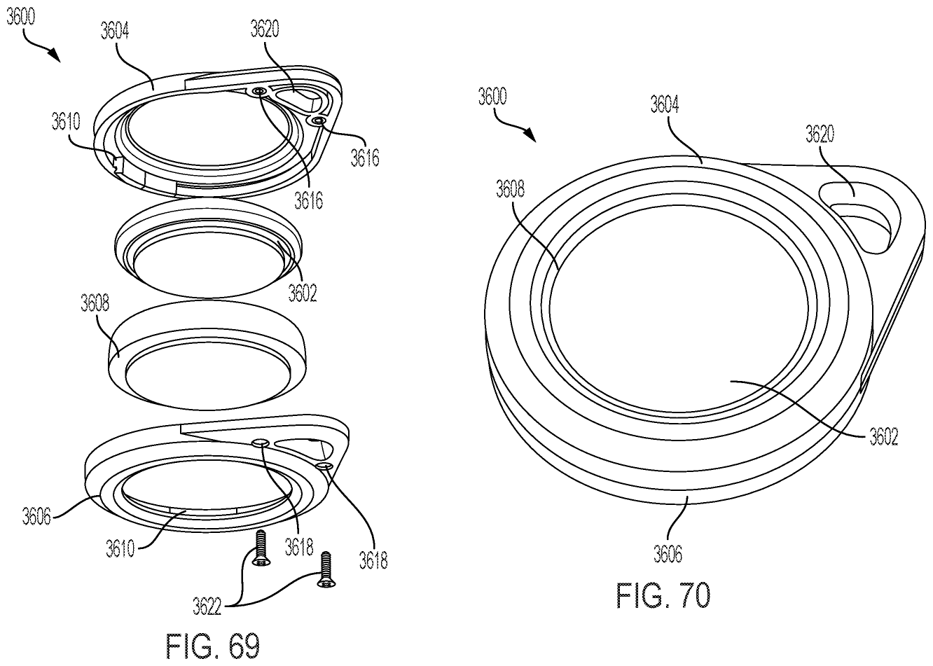

Referring to FIGS. 69 and 70, a case 3600 for an electronic tracking device 3602 is depicted. The case 3600 may generally include a cap 3604, a base 3606, and a sleeve 3608 similar to the other embodiments described herein. As such, the case 3600 may include any of the features disclosed above. The cap 3604 may include a pair of mounting holes 3616 and an alignment feature 3610. The base 3606 may include an pair of mounting holes 3618. The base 3606 may be configured to engage with the alignment feature 3610 of the cap 3604 to align the base 3606 and the cap 3604. The alignment feature 3610 is configured to align the cap 3604 with the base 3606 such that the mounting holes 3616 of the cap 3604 are aligned with the mounting holes 3618 of the base 3606. When the mounting holes 3616 of the cap 3604 are aligned with the mounting holes 3618 of the base 3606, the cap 3604 may be coupled to the base 3606 via fasteners 3622 extending through the mounting holes 3618 of the base 3606 and into the mounting holes 3616 of the cap 3604. The fasteners 3622 prevent the case 3600 from being opened without the fasteners being uncoupled from the cap 3604 and the base 3606. The fasteners 3622 may include a custom-shaped cavity to prevent the case 3600 from being opened by traditional screw drivers, and may require a special tool to open. The cap 3604 and/or the base 3606 may further include a hanging opening 3620 configured to receive a coupling component, such as a carabiner, to couple the case 3600 to an external object.

Embodiments may be further described with reference to the following numbered clauses:

1. A case for an electronic tracking device, the case includes a base defining a cavity, a cap including a front member and one or more sidewalls that extend transversely from an inner surface of the front member, and a sealing member positioned between the cap and the base, wherein the cap is releasably coupled to the base and, when coupled to the base, the sealing member is compressed between the cap to the base to seal the cavity in the base.

2. The case according to clause 1, wherein the cap further includes a plurality of external threads positioned on an external surface of the one or more sidewalls. The base includes a plurality of internal threads that are complimentary to the plurality of external threads of the cap. The cap is releasably coupled to the base via engagement between the internal threads and the external threads.

3. The case according to either of clauses 1 and 2, further including a second sealing member, wherein the front member defines an aperture extending therethrough, and the second sealing member circumferentially surrounds the aperture of the cap. When the cap is coupled to the base, the sealing member is compressed between the cap and the base to at least partially seal the cavity in the base, and the second sealing member is positioned to be compressed between the cap and the electronic tracking device when the electronic tracking device is positioned in the cavity.

4. The case according to clause 3, wherein the one or more sidewalls of the cap includes an exterior surface and defines a channel formed in the exterior surface, and the sealing member is positioned in the channel to circumferentially surround the exterior surface of the one or more sidewalls of the cap.

5. The case according to clause 3, wherein the one or more sidewalls include a terminating surface, and define a channel in the terminating surface, and the sealing member is positioned in the channel to be positioned between the terminating surface and the base.

6. The case according to any of clauses 3-5, wherein the cap defines a channel in the inner surface of the cap, and the second sealing member is positioned in the channel.

7. The case according to clause 1, wherein the sealing member is a covering member that is frustoconical in shape with an apex and a base, the apex includes at least one raised portion that aligns the covering member with the front member of the cap, the covering member at least partially receives the electronic tracking device.

8. The case according to clause 7, wherein the cap includes a groove formed within an exterior surface of a sidewall, and the base includes at least one protrusion extending from an interior surface of a sidewall, the groove of the cap is complementary to the at least one protrusion to receive the at least one protrusion of the base. The cap is releasably coupled to the base via engagement of the at least one protrusion and the groove.

9. The case according to any of clauses 1-8, wherein the base includes a non-planar rear surface, and an attachment element is coupled to the non-planar rear surface.

10. The case according to any of clauses 1-8, further including an attachment assembly configured to retain an external item to attach the electronic tracking device to the external item, wherein the attachment assembly includes an extension arm spaced apart from a main body of the base to facilitate attachment of the external item.

11. The case according to clause 10, wherein the external item includes one of a dog collar, a watch band, a bracelet, and a strap.

12. The case according to any of clauses 1-8, further including an attachment assembly configured to retain an external item to attach the electronic tracking device to the external item, wherein the attachment assembly includes a collar and a pair of pins, and the pair of pins selectively couple the collar to the base.

13. The case according to any of clauses 1-7, further including an external tool including a pair of ridges, wherein the cap includes a raised edge extending from the front member and a plurality of grooves formed in the raised edge, the grooves are keyed to be engaged by the pair of ridges of the external tool.

14. The case according to any of clauses 1-7, wherein the base further includes an inner surface that at least partially defines the cavity, an outer surface opposite the inner surface, and a hollow protrusion extending from the outer surface, the hollow protrusion defines a second cavity configured to provide a buoyancy force so that the case is buoyant.

15. The case according to clause 14, wherein the hollow protrusion includes a tab and defines an aperture extending through the tab, the aperture is configured to couple to an external object.

16. A case for an electronic tracking device including a sleeve, a body, and a locking mechanism. The sleeve includes an end wall and an annular wall extending from the end wall, the end wall and the annular wall defining a cavity configured to receive the electronic tracking device. The body includes a hinge and an opening, the body configured to receive the sleeve through the opening such that the annular wall of the sleeve abuts an inner surface of the body. The locking mechanism is configured to lock the sleeve and the base together, wherein the annular wall of the sleeve is compressed by the inner surface of the base to seal the cavity.

17. The case according to clause 16, wherein the hinge includes a living hinge.

18. The case according to either of clauses 16 and 17, wherein the body further includes a first prong and a second prong that engage the locking mechanism to couple the locking mechanism to the body.

19. The case according to any of clauses 16-18, wherein the locking mechanism defines an aperture for receiving an attachment device.

20. The case according to any of clauses 16-19, wherein the sleeve further includes a plurality of sealing projections that extend from an inner surface of the annular wall to contact the electronic tracking device.

21. A case for an electronic tracking device including a cap including an end wall and an annular wall extending from the end wall, the end wall and the annular wall defining a cavity configured to receive the electronic tracking device, and wherein an inner surface of the annular wall contacts the electronic tracking device to seal the cavity.

22. The case according to clause 21, further includes an attachment device coupled to the cap.

23. The case according to clause 21, further including an attachment body defining an opening for receiving the cap, and a plurality of apertures, and a plurality of attachment devices coupled to the plurality of apertures.

24. The case according to clause 21, further including: a tag extending from a periphery of the cap, an attachment device extending through the tag, and a tamper resistant mechanism configured to at least one of prevent tampering or notify a user of an attempted or actual tampering.

25. A case for an electronic tracking device including an inner sleeve and an outer sleeve. The inner sleeve includes an end wall and an annular wall extending from the end wall, the end wall and the annular wall defining an opening configured to receive the electronic tracking device such that a first side of the electronic tracking device abuts the end wall of the inner sleeve, wherein the annular wall further includes an outer surface defining sealing formations. The outer sleeve includes an end wall and an annular wall extending from the end wall, the end wall and the annular wall defining a cavity configured to receive the inner sleeve when assembled with the electronic tracking device such that a second side of the electronic tracking device abuts the end wall, wherein the annular wall further includes an inner surface including outer sealing formations. The sealing formations and the outer sealing formations couple the outer sleeve to the inner sleeve to seal the opening of the inner sleeve.

26. The case according to clause 25, wherein the end wall of the inner sleeve is formed of an acoustic membrane.

27. A lock for retaining an electronic tracking device, the lock including a base. and a retaining member operable to enclose the electronic tracking device between the retaining member and the base.

28. The lock according to clause 27, further including a locking arm including an elongated portion extending from the base and a locking portion, the locking arm being movable between an engaged position and a disengaged position, in the engaged position, the locking portion is coupled to the base, and in the disengaged position, the locking portion is spaced apart from the base.

29. The lock according to clause 28, wherein the retaining member is coupled to the locking arm, in the engaged position, the retaining member is in contact with the base.

30. The lock according to clause 27, wherein the base is rotatably coupled to the retaining member to be movable between an open position and a closed position, in the open position, the base and the retaining member are operable to receive the electronic tracking device. and in the closed position, the base and the retaining member are operable to enclose the electronic tracking device.

31. A case for an electronic tracking device, the case including a cap, a base coupled to the cap, the base and the cap are configured to enclose the electronic tracking device, and an attachment assembly including an attachment member that is coupled to the cap, a pair of tethers extending from the attachment member, and a pair of deformable cups coupled to each of the tethers.

32. A wearable case for an electronic tracking device, the case including a housing including a pair of bands extending from a main body of the housing, and a cavity formed in the main body, the pair of bands are configured to be selectively coupled together, and a back-plate coupled to the housing to enclose the cavity, the cavity is configured to receive the electronic tracking device.

33. A case for an electronic tracking device, the case including a sleeve including an inner cavity configured to receive the electronic tracking device, a rim, and a groove formed therein, and a fixing ring positioned in the groove of the sleeve.

It is noted that the terms “substantially” and “about” may be utilized herein to represent the inherent degree of uncertainty that may be attributed to any quantitative comparison. value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A case for an electronic tracking device, the case comprising:
a base defining a cavity that receives the electronic tracking device;
a cap including a front member and one or more sidewalls that extend transversely from an inner surface of the front member; and
a sealing member positioned between the cap and the base, wherein the cap is releasably coupled to the base and, when coupled to the base, the sealing member is compressed between the cap to the base to seal the electronic tracking device in the cavity.

2. The case of claim 1, wherein:
the cap further includes a plurality of external threads positioned on an external surface of the one or more sidewalls; and
the base includes a plurality of internal threads that are complimentary to the plurality of external threads of the cap.
wherein the cap is releasably coupled to the base via engagement between the internal threads and the external threads.

3. The case of claim 1, further comprising a second sealing member, wherein:
the front member defines an aperture extending therethrough.
the second sealing member circumferentially surrounds the aperture of the cap, and
when the cap is coupled to the base, the sealing member is compressed between the cap and the base to at least partially seal the cavity in the base, and the second sealing member is positioned to be compressed between the cap and the electronic tracking device when the electronic tracking device is positioned in the cavity.

4. The case of claim 3, wherein:
the one or more sidewalls of the cap includes an exterior surface and defines a channel formed in the exterior surface, and
the sealing member is positioned in the channel to circumferentially surround the exterior surface of the one or more sidewalls of the cap.

5. The case of claim 3, wherein:
the one or more sidewalls include a terminating surface, and define a channel in the terminating surface, and
the sealing member is positioned in the channel to be positioned between the terminating surface and the base.

6. The case of claim 3, wherein:
the cap defines a channel in the inner surface of the cap, and
the second sealing member is positioned in the channel.

7. The case of claim 1, wherein the sealing member is a covering member that is frustoconical in shape with an apex and a base, the apex includes at least one raised portion that aligns the covering member with the front member of the cap, the covering member at least partially receives the electronic tracking device.

8. The case of claim 7, wherein:
the cap includes a groove formed within an exterior surface of the sidewall; and
the base includes at least one protrusion extending from an interior surface of a sidewall. the groove of the cap is complementary to the at least one protrusion to receive the at least one protrusion of the base.
wherein the cap is releasably coupled to the base via engagement of the at least one protrusion and the groove.

9. The case of claim 1, wherein the base includes a non-planar rear surface, and an attachment element is coupled to the non-planar rear surface.

10. The case of claim 1, further comprising an attachment assembly configured to retain an external item to attach the electronic tracking device to the external item, wherein the attachment assembly comprises an extension arm spaced apart from a main body of the base to facilitate attachment of the external item.

11. The case of claim 10, wherein the external item comprises one of a dog collar. a watch band, a bracelet, and a strap.

12. The case of claim 1, further comprising an attachment assembly configured to retain an external item to attach the electronic tracking device to the external item, wherein the attachment assembly comprises a collar and a pair of pins, and the pair of pins selectively couple the collar to the base.

13. The case of claim 1, further comprising an external tool including a pair of ridges, wherein the cap includes a raised edge extending from the front member and a plurality of grooves formed in the raised edge, the grooves are keyed to be engaged by the pair of ridges of the external tool.

14. The case of claim 1, wherein the base further comprises an inner surface that at least partially defines the cavity, an outer surface opposite the inner surface, and a hollow protrusion extending from the outer surface, the hollow protrusion defines a second cavity configured to provide a buoyancy force so that the case is buoyant.

15. The case of claim 14, wherein the hollow protrusion includes a tab and defines an aperture extending through the tab, the aperture is configured to couple to an external object.

16. A case for an electronic tracking device, the case comprising:
a sleeve comprising an end wall and an annular wall extending from the end wall, the end wall and the annular wall defining a cavity configured to receive the electronic tracking device;
a body comprising a hinge and an opening, the body configured to receive the sleeve through the opening such that the annular wall of the sleeve abuts an inner surface of the body; and
a locking mechanism configured to lock the sleeve and the base together, wherein the annular wall of the sleeve is compressed by the inner surface of the base to seal the electronic tracking device within the cavity.

17. The case of claim 16, wherein the hinge comprises a living hinge.

18. The case of claim 16, wherein the body further comprises a first prong and a second prong that engage the locking mechanism to couple the locking mechanism to the body.

19. The case of claim 16, wherein the locking mechanism defines an aperture for receiving an attachment device.

20. The case of claim 16, wherein the sleeve further comprises a plurality of sealing projections that extend from an inner surface of the annular wall to contact the electronic tracking device.

21-33. (canceled)
